(19) United States
(12) Patent Application Publication
(10) Pub. No.: US 2026/0157828 A1
(43) Pub. Date: Jun. 11, 2026

(54) STRUCTURED LIGHT WITH UNIFORM ILLUMINATION

(71) Applicant: Align Technology, Inc., San Jose, CA (US)

(72) Inventor: Ofer Saphier, Rechovot (IL)

(21) Appl. No.: 19/405,272

(22) Filed: Dec. 1, 2025

Related U.S. Application Data
(60) Provisional application No. 63/728,899, filed on Dec. 6, 2024.

(51) Int. Cl. A61C 9/00

(52) U.S. Cl. CPC A61C 9/0073; A61C 9/006

(57) ABSTRACT

A system comprises a scanner and a computing device. The scanner comprises structured light projectors configured to project first structured light at a first time and second structured light at a second time, one or more non-structured light projectors to project non-structured light at the second time, and one or more cameras to capture first image data of the first structured light and second image data of the second structured light and the non-structured light. The computing device is configured to generate a 3D surface based on the first image data, separate a structured light portion of the second image data from a non-structured light portion of the second image data, determine a position and orientation of the non-structured light portion relative to the 3D surface based on the structured light portion, and augment the 3D surface using the non-structured light portion of the second image data.

### RELATED APPLICATIONS

This patent application claims the benefit under 35 U.S.C. § 119(e) of U.S. Provisional Application No. 63/728,899, filed Dec. 6, 2024, which is herein incorporated by reference.

### TECHNICAL FIELD

Embodiments of the present disclosure relate to the field of intraoral scanning and, in particular, to a system and method for using structured light to improve the usefulness of image data captured using nonstructured (e.g., uniform or smooth) illumination.

### BACKGROUND

In prosthodontic procedures designed to implant a dental prosthesis in the oral cavity, the dental site at which the prosthesis is to be implanted in many cases should be measured accurately and studied carefully, so that a prosthesis such as a crown, denture or bridge, for example, can be properly designed and dimensioned to fit in place. A good fit enables mechanical stresses to be properly transmitted between the prosthesis and the jaw, and to prevent infection of the gums via the interface between the prosthesis and the dental site, for example.

Some procedures also call for prosthetics to be fabricated to replace one or more missing teeth, such as a partial or full denture, in which case the surface contours of the areas where the teeth are missing need to be reproduced accurately so that the resulting prosthetic fits over the edentulous region with even pressure on the soft tissues.

In some practices, the dental site is prepared by a dental practitioner, and a positive physical model of the dental site is constructed using known methods. Alternatively, the dental site may be scanned to provide 3D data of the dental site. In either case, the virtual or real model of the dental site is sent to the dental lab, which manufactures the prosthesis based on the model. However, if the model is deficient or undefined in certain areas, or if a preparation was not optimally configured for receiving the prosthesis or is inaccurate, the design of the prosthesis may be less than optimal.

In orthodontic procedures it can be important to provide a model of one or both jaws. Where such orthodontic procedures are designed virtually, a virtual model of the dental arches is also beneficial. Such a virtual model may be obtained by scanning the oral cavity directly, or by producing a physical model of the dentition, and then scanning the model with a suitable scanner.

Thus, in both prosthodontic and orthodontic procedures, obtaining a three-dimensional (3D) model of a dental arch in the oral cavity is an initial procedure that is performed. When the 3D model is a virtual model, the more complete and accurate the scans of the dental arch are, the higher the quality of the virtual model, and thus the greater the ability to design an optimal prosthesis or orthodontic treatment appliance(s).

Some intraoral scanners use structured light projection in order to gather three-dimensional (3D) information about scanned oral structures (e.g., teeth, gingiva, etc. one the upper and/or lower dental arches).

### SUMMARY

In a first aspect of the disclosure, a method comprises: projecting first structured light onto an object at a first time; capturing first image data of the first structured light projected onto the object; generating a three-dimensional (3D) surface based on the first image data; concurrently projecting second structured light an non-structured light onto the object at a second time; capturing second image data of the second structured light and the non-structured light projected onto the object; separating a structured light portion of the second image data from a non-structured light portion of the second image data; determining a position and orientation of the non-structured light portion of the second image data relative to the 3D surface based on the structured light portion of the second image data; and after determining the position and orientation of the non-structured light portion of the second image data relative to the 3D surface, augmenting the 3D surface using the non-structured light portion of the second image data.

In a second aspect of the disclosure, a method comprises: projecting first structured light onto an object at a first time; capturing first image data of the first structured light projected onto the object; generating a three-dimensional (3D) surface based on the first image data; concurrently projecting second structured light and non-structured light onto the object at a second time; capturing second image data of the second structured light and the non-structured light projected onto the object; determining a position and orientation of the second image data relative to the 3D surface based on pattern features of the second structured light captured in the second image data; and after determining the position and orientation of the second image data relative to the 3D surface, augmenting the 3D surface using the second image data.

In a third aspect of the disclosure, a method comprises: projecting first structured light onto an object at a first time; capturing first image data of the first structured light projected onto the object; generating a first point cloud based on the first image data; concurrently projecting second structured light and non-structured light onto the object at a second time; capturing second image data of the second structured light and the non-structured light projected onto the object; separating a structured light portion of the second image data from a non-structured light portion of the second image data; projecting the first structured light onto the object at a third time that is after the second time; capturing third image data of the first structured light projected onto the object; generating a second point cloud based on the third image data; and stitching the first point cloud and the second point cloud using the separated structured light portion of the second image data.

In a fourth aspect of the disclosure an intraoral scanning system comprising an intraoral scanner and a computing device may perform the methods of any of the first through third aspects of the disclosure.

### BRIEF DESCRIPTION OF THE DRAWINGS

The present disclosure is illustrated by way of example, and not by way of limitation, in the figures of the accompanying drawings.

FIG. 1A illustrates an intraoral scanner comprising a plurality of structured light projectors, a plurality of cameras, and one or more nonstructured light projectors and an image captured of structured light as projected by the plurality of structured light projectors, in accordance with embodiments of the present disclosure.

FIG. 1B illustrates the intraoral scanner of FIG. 1A and an image captured of structured light as projected by the one of the structured light projectors and nonstructured light as projected by an nonstructured light projector, in accordance with embodiments of the present disclosure.

FIGS. 2A-B are timing diagrams showing the timing of light projection by various light projectors of an intraoral scanner, in accordance with one embodiment.

FIG. 3A illustrates a flow diagram for a method of using concurrently projected structured light and nonstructured light to augment a 3D surface generated using structured light projection, in accordance with embodiments of the present disclosure.

FIG. 3B illustrates a flow diagram for a method of using concurrently projected structured light and nonstructured light to augment a 3D surface generated using structured light projection, in accordance with embodiments of the present disclosure.

FIG. 3C illustrates a flow diagram for a method of using concurrently projected structured light and nonstructured light to facilitate stitching between image data generated using structured light projection without nonstructured light projection, in accordance with embodiments of the present disclosure.

FIG. 3D illustrates a flow diagram for a method of using concurrently projected structured light and nonstructured light to augment a 3D surface generated using structured light projection, in accordance with embodiments of the present disclosure.

FIG. 3E illustrates a flow diagram for a method of separating a structured light portion of image data from an nonstructured light portion of image data, in accordance with embodiments of the present disclosure.

FIG. 3F illustrates a flow diagram for a method of selectively illuminating a region of interest, in accordance with embodiments of the present disclosure.

FIG. 3G illustrates a flow diagram for a method of adjusting the intensity of structured light that is concurrently projected with nonstructured light, in accordance with embodiments of the present disclosure.

FIG. 3H illustrates a flow diagram for a method of separating first structured light from second structured light in image data, in accordance with embodiments of the present disclosure.

FIG. 4 illustrates one embodiment of a system for performing intraoral scanning and generating a virtual 3D model of a dental arch.

FIG. 5 is a schematic illustration of a wand (e.g., intraoral scanner) with a plurality of structured light projectors and cameras disposed within a probe at a distal end of the wand, in accordance with embodiments of the present disclosure.

FIG. 6 is a chart depicting a plurality of different configurations for the position of the structured light projectors and the cameras in the probe of FIG. 5A, in accordance with embodiments of the present disclosure.

FIG. 7 is a schematic illustration of a structured light projector projecting a distribution of discrete unconnected spots of light onto a plurality of object focal planes, in accordance with embodiments of the present disclosure.

FIGS. 8A-B are schematic illustrations of a structured light projector projecting discrete unconnected spots and a camera sensor detecting spots, in accordance with embodiments of the present disclosure.

FIG. 9 is a flow chart outlining a method for determining depth values of points in an intraoral scan, in accordance with embodiments of the present disclosure.

FIG. 10 is a flowchart outlining a method for carrying out a specific operation in the method of FIG. 9, in accordance with embodiments of the present disclosure.

FIGS. 11, 12, 13, and 14 are schematic illustrations depicting a simplified example of the operations of FIG. 10, in accordance with embodiments of the present disclosure.

FIG. 15 is a flow chart outlining further operations in the method for generating a digital three-dimensional image, in accordance with embodiments of the present disclosure.

FIGS. 16, 17, 18, and 19 are schematic illustrations depicting a simplified example of the operations of FIG. 15, in accordance with embodiments of the present disclosure.

FIG. 20 illustrates a block diagram of an example computing device, in accordance with embodiments of the present disclosure.

### DETAILED DESCRIPTION

Described herein is a method and apparatus for using structured light projection to augment images generated using nonstructured (e.g., uniform or smooth) light projection. Embodiments may improve the usefulness of two-dimensional (2D) images (e.g., images generated using nonstructured light projection) in intraoral scanning. In particular, embodiments provide an intraoral scanner that includes both structured light projectors and nonstructured light projectors. The intraoral scanner projects structured light using all or a subset of the structured light projectors during projection of nonstructured light by one or more nonstructured light projectors. Such concurrent projection of the structured light and the nonstructured light provides some 3D information about an object captured in image data generated using one or more cameras of the intraoral scanner during the concurrently projected structured light and nonstructured light.

An intraoral scanner may perform imaging using multiple different imaging modalities during intraoral scanning. The imaging modalities may include 3D scanning, 2D imaging using white light (e.g., to generate 2D color images), 2D imaging using infrared or near-infrared light (referred to jointly as infrared light or NIRI for convenience), 2D imaging using ultraviolet light (e.g., for fluorescence imaging), and so on. 3D imaging is performed using structured light projection in embodiments. The 2D imaging using white light, 2D imaging using ultraviolet light, and 2D imaging using infrared light may each be performed using nonstructured light in embodiments.

In embodiments, structured light images (images generated using 3D scanning based on structured light imaging) are the main source of information for building a 3D model. Each capture of structured light images may involve multiple cameras of an intraoral scanner capturing an image of structured light (of a structured light pattern) projected onto an object such as a tooth at a same time. From these multiple images, a point cloud (optionally referred to as an intraoral scan) may be generated in 3D. Subsequent point clouds generated at different times are registered and stitched together. By stitching multiple point clouds (i.e., intraoral scans) together, a full 3D model of the scanned object may be built. Each such stitching operation can be thought about as giving relative position information between the object scanned and the intraoral scanner.

Traditionally, the intraoral scanner alternates between the different imaging modalities. However, in embodiments the 3D scanning imaging modality is performed concurrently with one or more 2D imaging modalities (e.g., infrared imaging, fluorescence imaging, color imaging).

There is some tradeoff between imaging using structured light (e.g., the amount of structured light images captured) and imaging using nonstructured light (e.g., the amount of 2D images captured using the other imaging modalities) in embodiments. Increasing an amount of structured light (SL) information (e.g., a number of frames captured using structured light projection) increases a number of data points for a constructed 3D model (and therefore increases an accuracy and quality of the 3D model). However, the other imaging modalities provide additional functionality, such as identification of caries, tooth staining, gingival inflammation, and so on. Additionally, information from the other imaging modalities (each of which uses nonstructured light), may be used to assist in generating the 3D model. For example, white light (e.g., color) images may be used to better define an inter-proximal space between adjacent teeth, as described U.S. application Ser. No. 18/645,346, filed Apr. 26, 2024, which is incorporated by reference herein in its entirety. In another example, white light images may be used to build 3D surfaces using stereo imaging techniques and/or simultaneous localization and mapping (SLAM) techniques, such as for surfaces that structured light projection cannot reach.

An additional disadvantage of non-SL images is that it is difficult to accurately estimate a position and orientation of the intraoral scanner relative to the object being scanned when structured light projection is not used. Knowing exactly where the intraoral scanner (e.g., wand or probe of the intraoral scanner, and thus the cameras of the intraoral scanner) are relative to the object being imaged improves the accuracy of texture mapping and other functions.

When point clouds (e.g., intraoral scans generated using structured light projection) are stitched together, if there is a larger gap in time between when the two intraoral scans were generated (e.g., introduced because nonstructured light imaging was performed for one or more frames between structured light projection imaging), this results in less overlap between the point clouds, which reduces stitching accuracy. Accordingly, there is generally a careful balance between the amount of structured light projection imaging and nonstructured light projection imaging that is alternately performed by an intraoral scanner.

With infrared imaging (including near-infrared imaging (NIRI)), there may be multiple infrared light projectors (e.g., light emitting diodes (LEDs)) which may be used alternately (e.g., to provide different NIRI illuminations at different times) to remove direct reflections and to improve the contrast of the near IR image (and associated caries detection features), as explained in U.S. patent application Ser. No. 17/869,698, filed Jul. 20, 2022, which is incorporated by reference herein in its entirety. Preferably, the time between the two NIRI images should be minimized. However, if two NIRI images are captured one after the other, the distance between the SL images will be greater, which may cause increased stitching inaccuracies. Accordingly, there is a tradeoff between accuracy and quality of the NIRI images (e.g., increased quality/accuracy by taking multiple NIRI images with different illumination in a row and decreased quality/accuracy by spreading out when the multiple NIRI images with different illumination are captured) and the accuracy and quality of stitching performed to produce a 3D model (e.g., increased quality/accuracy by spreading out when the multiple NIRI images with different illumination are captured and decreased quality/accuracy by taking multiple NIRI images with different illumination in a row). This dilemma can be solved by concurrently performing structured light projection and nonstructured light projection of infrared light, resulting in both high accuracy/quality NIRI images and high accuracy/quality stitching of intraoral scans.

Introducing structured light projection during one or more of the other imaging modalities introduces challenges that can reduce a quality and/or accuracy of images generated using the other imaging modalities. Accordingly, there are disadvantages in concurrently using structured light projection and nonstructured light projection in intraoral imaging. However, such concurrent use of structured light projection and nonstructured light projection also have many advantages, as set forth above. Embodiments discussed herein introduce techniques of concurrently using structured light projection and nonstructured light projection in a manner that mitigates the disadvantages (e.g., solves the challenges) associated with concurrent use of structured light projection and nonstructured light projection while taking advantage of the advantages of concurrent use of structured light projection and nonstructured light projection. Accordingly, in embodiments both structured light projectors and nonstructured light projectors illuminate an object (e.g., an intraoral object such as a tooth) at a same time, and thus are both captured in the same exposure of one or more cameras of an intraoral scanner.

In embodiments, interference between the concurrently projected structured light and nonstructured light is introduced in images generated during such concurrent projection of the structured light and the nonstructured light. As used herein, “interference” between structured light and non-structured light does not refer to coherent interference, but merely refers to the structured light interfering with a capability of the intraoral scanning system to capture an image of the uniform light and the uniform light interfering with a capability of the intraoral scanning system to capture an image of the structured light. Each of the structured light illumination and the non-structured light illumination may be considered to create a different image, and the sum of these two images is captured by image sensors when the structured light and non-structured light are projected concurrently. Interference may refer to interference between accurate capture of the structured light image and accurate capture of the non-structured light image. Embodiments herein introduce techniques to overcome this interference, and to separate out structured light from nonstructured light in captured images. Accordingly, a separate structured light image and nonstructured light image may be determined from a single image that has combined structured light and nonstructured light information. The structured light image may be used to generate a 3D image (e.g., a 3D point cloud), and the nonstructured light image may be a 2D image, such as a 2D color image or NIRI image. Since the two images were generated at a same time, the relative position and orientation of the intraoral scanner to the object scanned is the same between the two images. The 3D point cloud may be used to determine a position and orientation of both images relative to the intraoral scanner. Additionally, the 3D point cloud may be registered and stitched to a 3D surface (e.g., a 3D model) already generated or partially generated using structured light projection. This may provide a relative position and orientation of both the 3D point cloud and the 2D image relative to the object scanned and to the 3D surface. Accordingly, the 3D point cloud (i.e., a structured light portion of captured image data) may be used to determine a position and orientation of the 2D image (e.g., an nonstructured light portion of the captured image data). Once this position and orientation are accurately determined, information from the 2D image (e.g., the nonstructured light portion of the captured image data) may be used to enhance the 3D surface/model, such as by adding a texture (e.g., color, NIRI data, etc.) to the 3D surface.

In some embodiments, an intraoral scanner includes multiple structured light projectors, multiple nonstructured light projectors, and multiple cameras. The structured light projectors are each configured to project structured light including a light pattern onto a dental site (e.g., an oral structure such as a tooth, gingiva, dental arch, or portion thereof). As used herein, the term “structured light” refers to light that forms a light pattern comprising a plurality of pattern features. The light pattern may be, for example, a pattern of spots, a checkerboard pattern, a pattern of lines, a grid pattern, and so on. The structured light may be structured coherent light (e.g., light having one or a few specific wavelengths and/or structured non-coherent light (e.g., white light). The nonstructured light projectors are each configured to project an nonstructured (e.g., uniform or smooth) light onto the dental site. As used herein, the term “uniform light” refers to light that is not structured (e.g., that does not form a light pattern). Uniform light may be light that is generated using one or more simple point sources and/or area light sources that create a smooth illumination. Though the term “uniform light” is used, the light may actually include non-uniformities. For example, the “uniform light” may exhibit a drop in intensity at an edge of the field of illumination. The term “uniform light” is merely used herein to contrast with the structured light. The cameras are configured to image the dental site illuminated by the structured light patterns of the structured light projectors and the nonstructured light of the nonstructured light projectors. In an example, the multiple structured and nonstructured light projectors and multiple cameras may be arranged at or near a tip (e.g., distal end) of the intraoral scanner while keeping the tip of the intraoral scanner to a minimum size and height.

The multiple projectors and multiple cameras of the intraoral scanner enable the intraoral scanner to have an enlarged field of view (e.g., as compared to an intraoral scanner having a single light projector and/or a single camera). The enlarged field of view enables the intraoral scanner to achieve higher accuracy and faster intraoral scanning as compared to an intraoral scanner that lacks multiple light projectors and/or that lacks multiple cameras.

One problem introduced by concurrent projection of structured light and nonstructured light by an intraoral scanner is interference between the structured light and the nonstructured light. Interference introduced by multiple light projectors may include direct interferences (e.g., where light output by one light projector partially overlaps light output by another light projector) and indirect interference (e.g., where light scattered from a first light projector reduces a signal to noise ratio of a camera detecting information associated with second light of a second light projector (e.g., features of a structured light pattern). The denser the light patterns of structured light projection of an intraoral scanner, the greater the amount of light scattering that occurs of projected structured light, and thus the lower the signal to noise ratio associated with nonstructured light imaging. Even where there is little or no direct interference, percolation and stray light from one projector may still reach the field of illumination of the other light projector, which may reducing a signal to noise ratio for detection of the pattern features of the light pattern projected by the structured light projector. Additionally, the greater the amount of light introduced by the structured light, the lower the signal to noise ratio of the nonstructured light, and thus the more difficult it is to perform functions such as accurate color detection of oral objects, caries detection, and so on.

In embodiments, a structured light pattern comprising a reduced density of pattern features is used during concurrent structured light projection and nonstructured light projection than is used during structured light projection alone to reduce an amount of interference between the structured light and the nonstructured light. For example, structured light projection alone may use hundreds, thousands, or more pattern features, while structured light projection used concurrently with nonstructured light projection may use only a handful of pattern features (e.g., such as 9-50 pattern features). For example, an intraoral scanner may include multiple structured light projectors that project structured light having a first wavelength (e.g., 3 blue structured light projectors) and multiple additional structured light projectors that project structured light having a second wavelength (e.g., 2 green structured light projectors). All of the structured light projectors may be used during structured light projection on its own, and 1-2 of the green or blue structured light projectors may be used during concurrent structured light projection and nonstructured light projection. Alternatively, all structured light projectors may be used during concurrent structured light projection and nonstructured light projection and/or the same number of pattern features may be projected during concurrent structured light projection and nonstructured light projection as are projected during only structured light projection.

A light pattern of structured light includes a plurality of pattern features. Typically, a dense light pattern will have dense pattern features and a sparse light pattern will have sparse pattern features. However, in some embodiments a sparse pattern may have dense pattern features. The pattern features of a light pattern may include, for example, the corners of a checkerboard (e.g., for a checkerboard light pattern). In another example, pattern features may be discrete spots of light. When projecting a pattern comprising pattern features onto a surface of a 3D object, acquired images of the object will comprise a plurality of captured image features corresponding to the pattern features. A pattern feature and an image feature may be an individual well-defined location in the image feature or pattern feature. Examples of image features and pattern features include corners, edges, vertices, points, transitions, dots, stripes, and so on.

In some embodiments, the light projectors and cameras disposed at a distal end of an intraoral scanner are non-telecentric. Alternatively, in some embodiments the intraoral scanner includes a telecentric optical system. A camera may have a predefined field of view (FOV) and/or a predefined angular field of view (AFOV). Similarly, a light projector may have a predefined field of illumination (FOI) and/or a predefined angular field of illumination (AFOI). The field of view (FOV) of a camera in the intraoral scanner may be understood as the extent of the observable world that is seen at any given moment by the camera. The FOV may be reported as an area measure, e.g. an area at a given distance from the camera or at a given distance below the probe of the intraoral scanner. The angular field of view (AFOV) is correlated to the FOV, and the AFOI is correlated to the FOI. However, herein the AFOV and AFOI are expressed as angles and the FOV and FOI are expressed as an area. In embodiments, the light projectors have an AFOI that cause the FOI of the light projectors to become larger with increased distance from the intraoral scanner. Additionally or alternatively, the cameras have an AFOV that cause the FOV of the cameras to become larger with increased distance/depth from the intraoral scanner. The AFOI of the light projectors may cause light patterns projected by the respective light projectors to have different amounts of interference and/or overlap at different depths. Depth as used herein may refer to a distance between intraoral scanner (e.g., the light projector and/or camera of the intraoral scanner) and an imaged surface along an imaging axis that is orthogonal to a longitudinal axis of the intraoral scanner (e.g., to a longitudinal axis of a probe of the intraoral scanner that contains the cameras and light projectors).

Embodiments described herein provide multiple techniques for overcoming interference caused by concurrent structured light projection and nonstructured light projection. The techniques for overcoming such interference may be used singly or in combination in embodiments.

Embodiments provide improved techniques for generating 3D modes of dental arches that take advantage of large fields of view (FOV) and/or large ranges of depths of focus while compensating for interference between structured light and nonstructured light that is projected concurrently.

In some particular applications of the present disclosure, an apparatus is provided for intraoral scanning (i.e., an intraoral scanner), the apparatus including an elongate wand with a probe at the distal end. During a scan, the probe may be configured to enter the intraoral cavity of a subject. Multiple structured light projectors (e.g., miniature structured light projectors) and nonstructured light projectors (e.g., miniature nonstructured light projectors) as well as multiple cameras (e.g., miniature cameras) may be coupled to a rigid structure disposed within a distal end of the probe. Each of the light projectors transmits light using a light source, such as a laser diode, light emitting diode (LED), etc. Each of the structured light projectors may be configured to project structured light that includes a pattern of light defined by a plurality of projector rays when the light source is activated. Each camera may be configured to capture a plurality of images that depict at least a portion of the projected pattern of light as projected by the multiple light projectors on an intraoral surface when structured light projection is used. In some applications, the light projectors may have an AFOI of at least 45 degrees. Optionally, the AFOI may be less than 120 degrees. For structured light projectors, each of the structured light projectors may further include a pattern generating optical element. The pattern generating optical element may utilize diffraction and/or refraction to generate a light pattern (e.g., where coherent light is used). Alternatively, the pattern generating optical element may be a mask that blocks a portion of the light and passes a remainder of the light. The mask can be a static mask or a changing mask such as a digital micro-mirror (DMD), a display, etc. In some applications, the light pattern may be a distribution of discrete unconnected spots of light. In some applications, the light pattern may be a checkerboard pattern. Other light patterns such as grids, lines, regular distributions of polygons, etc. may additionally or alternatively be used. In some embodiments, different light patterns are used for structured light projection performed on its own (e.g., without concurrent nonstructured light projection) and for structured light projection performed concurrently with nonstructured light projection. In some embodiments, a portion of the structured light pattern used for structured light projection alone is used during concurrent structured light projection and nonstructured light projection. Optionally, the light pattern maintains a distribution of discrete unconnected spots or other pattern features at all planes located up to a threshold distance (e.g., 30 mm, 40 mm, 60 mm, etc.) from the pattern generating optical element, when the light source (e.g., laser diode) is activated to transmit light through the pattern generating optical element. Each of the cameras includes a camera sensor and objective optics including one or more lenses.

In some applications, in order to improve image capture of an intraoral scene under concurrent structured light illumination and nonstructured light illumination, one or more techniques for detecting and/or compensating for interference between the multiple types of illumination of the intraoral scanner are used. As described further hereinbelow, methods and systems are provided for solving a correspondence problem presented by the distribution of pattern features of a light pattern (or multiple light patterns) as projected by multiple structured light projectors of an intraoral scanner. In some applications, the light pattern from each projector may be non-coded.

In some applications, the AFOV of each of the cameras may be at least 45 degrees, e.g., at least 80 degrees, e.g., 85 degrees. Optionally, the AFOV of each of the cameras may be less than 120 degrees, e.g., less than 90 degrees. The fields of view of the various cameras may together form a field of view of the intraoral scanner. In any case, the fields of view and/or angular fields of view of the various cameras may be identical or non-identical. Similarly, the focal length of the various cameras may be identical or non-identical. Further, each camera may be configured to focus at an object focal plane that is located up to a threshold distance from the respective camera sensor (e.g., up to a distance of 10 mm, 20 mm, 30 mm, 40 mm, 50 mm, 60 mm, 70 mm, 80 mm, etc. from the respective camera sensor). As distances increase, the accuracy of the position of the detected surfaces decreases. In one embodiment, beyond the threshold distance the accuracy is below an accuracy threshold. Similarly, in some applications, the AFOI of each of the light projectors (e.g., structured light projectors and/or non-structured light projectors) may be at least 45 degrees and optionally less than 120 degrees. A large field of view (FOV) of the intraoral scanner achieved by combining the respective fields of view of all the cameras may improve accuracy (as compared to traditional scanners that typically have a FOV of 10-20 mm in the x-axis and γ-axis and a depth of capture of about 0-15 or 025 mm) due to reduced amount of image stitching errors, especially in edentulous regions, where the gum surface is smooth and there may be fewer clear high resolution 3-D features. Having a larger FOV for the intraoral scanner enables large smooth features, such as the overall curve of the tooth, to appear in each image frame, which improves the accuracy of stitching respective surfaces obtained from multiple such image frames.

In some applications, the total combined FOV of the various cameras (e.g., of the intraoral scanner) is between about 20 mm and about 50 mm along the longitudinal axis of the elongate wand, and about 20-60 mm (or 20-40 mm) in the z-axis, where the z-axis may correspond to depth. In further applications, the field of view may be about 20 mm, about 25 mm, about 30 mm, about 35 mm, or about 40 mm along the longitudinal axis and/or at least 20 mm, at least 25 mm, at least 30 mm, at least 35 mm, at least 40 mm, at least 45 mm, at least 50 mm, at least 55 mm, at least 60 mm, at least 65 mm, at least 70 mm, at least 75 mm, or at least 80 mm in the z-axis. In some embodiments, the combined field of view may change with depth (e.g., with scanning distance). For example, at a scanning distance of about 4 mm the field of view may be about 20 mm along the longitudinal axis, and at a scanning distance of about 20-50 mm the field of view may be about 30 mm or less along the longitudinal axis. If most of the motion of the intraoral scanner is done relative to the long axis (e.g., longitudinal axis) of the scanner, then overlap between scans can be substantial. In some applications, the field of view of the combined cameras is not continuous. For example, the intraoral scanner may have a first field of view separated from a second field of view by a fixed separation. The fixed separation may be, for example, along the longitudinal axis of the elongate wand.

In some embodiments, the large FOV of the intraoral scanner increases an accuracy of the detected depth of 3D surfaces. For example, the accuracy of a depth measurement of a detected 3D surface may be based on the longitudinal distance between two cameras or between a light projector and a camera, which may represent a triangulation baseline distance. In embodiments, cameras and/or light projectors may be spaced apart in a configuration that provides for increased accuracy of depth measurements for 3D surfaces that, for example, have a depth of up to 30 mm, up to 40 mm, 15-25 mm, and so on.

In some applications, a method is provided for generating a digital three-dimensional (3D) model of an intraoral surface. The 3D model may be a point cloud, from which an image of the three-dimensional intraoral surface may be constructed. The resultant image of the 3D model, while generally displayed on a two-dimensional screen, contains data relating to the three-dimensional structure of the scanned 3D surface, and thus may typically be manipulated so as to show the scanned 3D surface from different views and perspectives. Additionally, a physical three-dimensional model of the scanned 3D surface may be made using the data from the three-dimensional model. As discussed above, the 3D model may be a 3D model of a dental arch.

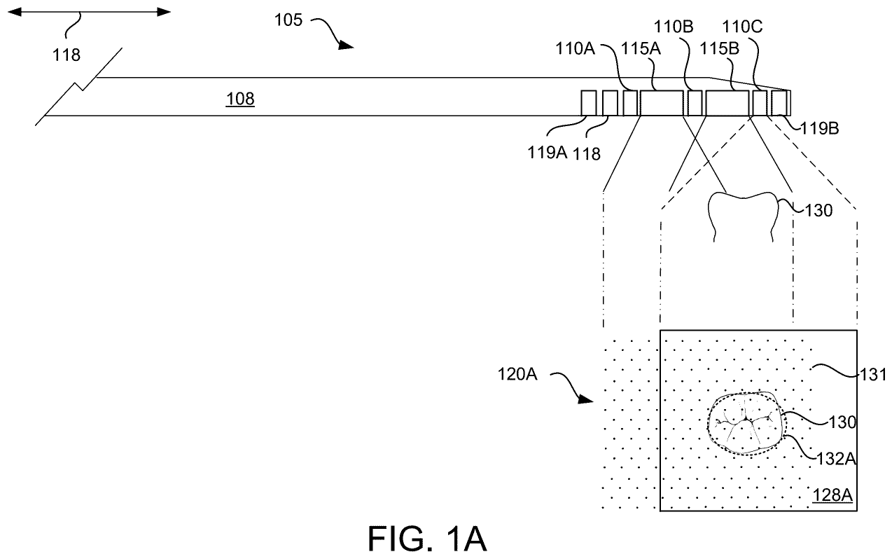

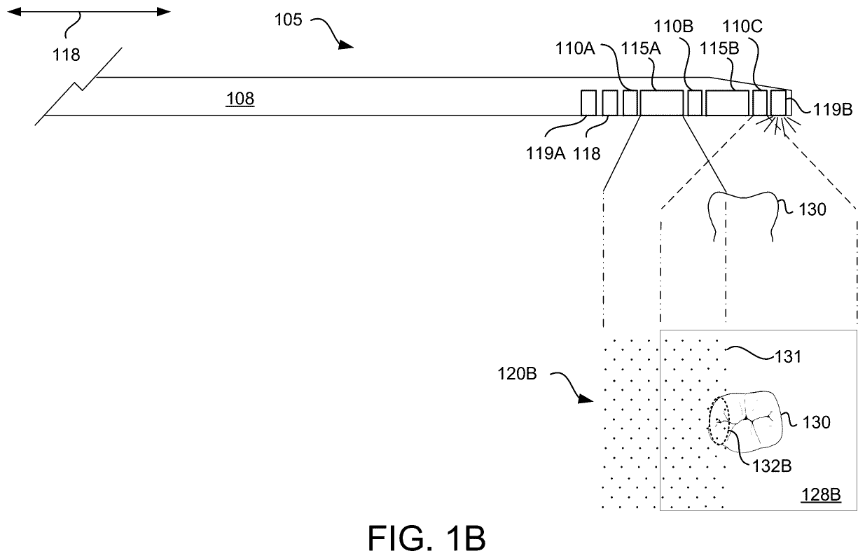

Turning now to the figures, FIG. 1A illustrates an intraoral scanner 105 comprising a plurality of structured light projectors (e.g., structured light projectors 115A, 115B), a plurality of nonstructured light projectors (e.g., white light projector 118 and NIRI light projectors 119A-B), and a plurality of cameras (e.g., cameras 110A, 110B, 110C), where multiple structured light projectors 115A-B are projecting structured light in parallel. In some embodiments, one or more additional types of nonstructured light projectors are also included in intraoral scanner 105, such as one or more ultraviolet nonstructured light projectors.

Intraoral scanner 105 includes a wand 108 and a probe at a distal end of the wand 108. The cameras 110A-C, structured light projectors 115A-B and nonstructured light projectors 118, 119A-B may be disposed in the probe along a longitudinal axis 118 of the probe (e.g., along a longitudinal axis of the intraoral scanner and/or wand), such as at a distal end of the probe and/or wand as shown. For ease of illustration two structured light projectors 115A-B, three nonstructured light projectors 118, 119A-B, and three cameras 110A-C are shown along the longitudinal axis 118. However, it should be understood that the intraoral scanner may include more than two light projectors and/or more than four cameras, which may be disposed at different positions along the longitudinal axis and/or along the transverse axis of the probe than those shown.

In some embodiments, the cameras 110A-C, nonstructured light projectors 118, 119A-B, and/or structured light projectors 115A-B are arranged in one or more component groupings, which may be referred to as scan units. In some embodiments, each scan unit includes a single structured light projector and four or more cameras disposed about the structured light projector. For example, each scan unit may include a camera on either side of the structured light projector along the longitudinal axis of the probe and a camera on either side of the structured light projector along the transverse axis of the probe. In embodiments, all cameras and all light projectors (e.g., all scan units) are positioned to face directly towards an object to be scanned. For example, the light projectors and cameras may be positioned approximately orthogonal to the longitudinal axis of the probe (e.g., within 35 degrees of orthogonal to the longitudinal axis). In some embodiments, all cameras and all light projectors (e.g., all scan units) are positioned to face a mirror (not shown) in the probe, and the mirror reflects projected light onto an object to be scanned and projects captured light from the object to be scanned back to the cameras. For example, the light projectors and cameras may be positioned approximately parallel to the longitudinal axis of the probe (e.g., within 35 degrees of parallel to the longitudinal axis). In some embodiments, some (e.g., one or more) cameras and/or light projectors (e.g., scan units) are positioned to directly face an object to be scanned while other cameras and/or light projectors (e.g., scan units) are positioned to face a mirror within the probe of the intraoral scanner 105. As shown, in some embodiments the structured light projectors 115A-B each have an AFOI that causes the FOI of the light projectors 115A-B to increase with distance/depth.

FIG. 1A also illustrates an example image 128A captured by a camera 110C of the plurality of cameras. As shown, image 128A is captured by camera 110C during projection of structured light by multiple structured light projectors (e.g., by both structured light projector 115A and 115B). This results in a structured light pattern 120A having many projected pattern features, at least some of which are captured in image 128A.

Image 128A is captured while a dental site (e.g., a tooth 130) is in the FOV of the intraoral scanner 105. As shown, the tooth 130 is in the FOV of at least camera 110C. In most cases, tooth 130 would also be in the FOV of one or more other cameras of intraoral scanner 105. However, the FOV of the other cameras and an illustration of the images captured by the other cameras is not shown for clarity.

Multiple pattern features 131 of the structured light pattern 120A are captured in image (or would be if they encountered a surface within the FOV of camera 110C). Thos pattern features 131 that intersect with the tooth 130 are captured in the image 128A. Captured pattern features 132A intersect the tooth across the entire occlusal surface of the tooth in the illustrated example.

In embodiments, each of the pattern features 132A that intersects the tooth may be identified (e.g., using image processing and/or application of machine learning). A correspondence problem may then be solved to determine coordinates in a 3D space for intersections of captured image features (i.e., features captured in image 128A) with projected pattern features (i.e., pattern features of the projected structured light). For each solved correspondence between projected pattern feature and a captured image feature, a 3D coordinate may be determined based on the correspondence, as described in greater detail below. The 3D coordinates may be assigned to the captured image features to generate a 3D point cloud in embodiments. When using a set of images of different cameras that were all captured at a same time, the correspondence problem can be solved across the set of images for improved accuracy.

FIG. 1B illustrates intraoral scanner 105, where structured light projector 115A is projecting a structured light pattern concurrently to nonstructured light projector 119B projecting nonstructured light.

FIG. 1B also illustrates an example image 128B captured by camera 110C of the plurality of cameras. As shown, image 128B is captured by camera 110C during projection of structured light by a single structured light projector 115A. In embodiments, the structured light projector 115A used to project the structured light may be a structured light projector that is furthest away from a camera capturing image 128B.

Image 128B is captured while the dental site (e.g., tooth 130) is in the FOV of the intraoral scanner 105 and while structured light pattern 120B and nonstructured light are concurrently projected onto the dental site. In some embodiments, only a fraction of the pattern features that may be projected by structured light projector 115A are projected. For example, a mask or optical element may be used to block projection of some of the pattern features 131 when structured light projector 115A and nonstructured light projector 119B are to concurrently project light.

In embodiments, each structured light projector 115A-B includes a light source that generates nonstructured light, and an optical element that converts the nonstructured light into structured light. The optical element may be, for example, a transmission mask. In one embodiment, the transmission mask of the light projectors 115A-B is a static transmission mask (e.g., a diffractive optical element, static mask, etc.). Alternatively, the transmission mask of the light projectors 115A-B may be an active mask. In embodiments, the projected pattern can be adjusted between structured light projection used on its own (e.g., without concurrent use of nonstructured light projection) and structured light projection used concurrently with nonstructured light projection to reduce a number of pattern features used for concurrent structured light projection and nonstructured light projection. The pattern features of one of the light patterns may be deactivated or blocked by the transmission mask. This may reduce a number of pattern features that are projected to an imaged object. In one embodiment, a static transmission mask may be used. The static transmission mask may be opened or closed, depending on a transmission mode. In one embodiment, an additional optical element may be disposed after the transmission mask along the optical axis of the light projector. The additional optical element may be a display or other element that can filter out or block pattern features that not to be projected. In one embodiment, a mask or other light blocking element may be disposed along the imaging axis after the transmission mask. The mask or other light blocking element may be moved linearly and/or between two or more positions to block a portion of one or more light patterns to reduce a number of projected pattern features.

Use of a single or a few structured light projector(s) reduces a number of pattern features that are projected during nonstructured light projection, minimizing interference of the structured light with the nonstructured light. Use of a single structured light projector (or otherwise a subset of all structured light projectors) for concurrent projection with nonstructured light provides a structured light pattern 120B having a reduced number pattern features.

A small number of pattern features 131 of the structured light pattern 120B are captured in image 128B (or would be if they encountered a surface within the FOV of camera 110C). Those pattern features 131 that intersect with the tooth 130 are captured in the image 128B. Captured pattern features 132B intersect the tooth across a small region of the occlusal surface of the tooth in the illustrated example.

The reduced number of captured pattern features 132B may be used to generate a 3D point cloud that has a reduced number of points as compared to the 3D point cloud generated from image 128A. The reduced 3D point cloud may however be sufficient to stitch to the 3D point cloud generated from image 128A and/or a 3D surface generated from such a 3D point cloud (e.g., by stitching that 3D point cloud to other 3D point clouds).

Since most of tooth 130 is outside of the field of illumination of structured light pattern 120B, there is reduced interference caused by the structured light pattern 120B to captured nonstructured light reflecting off of tooth 130. As a result, a NIRI image, color image, etc. may be captured with little to no interference caused by structured light pattern 120B. The 3D point cloud generated from captured pattern features 132B may be used to determine a position and orientation of the scanner 105 relative to the tooth 130 during image capture, and the position and orientation of the captured image 128B relative to a 3D surface and/or to the 3D point cloud generated from image 128A. This enables accurate information about the relative position and orientation of image 128A relative to, for example, a 3D model of a dental arch. This information can be used to accurately add texture information to the 3D model. For example, color information, NIRI information, etc. can be added to a 3D model of tooth 130 based on registering the point cloud generated from captured pattern features 132B to the 3D model.

Multiple different techniques for compensating for interference between concurrently projected structured light and nonstructured light may be used in embodiments. These interference compensation techniques may be applied singly and/or in any combination in embodiments.

One solution to addressing interference caused by concurrently projected structured light and nonstructured light is to provide a large distance between a structured light projector (e.g., structured light projector 115A) and an nonstructured light projector (e.g., nonstructured light projector 119B). In embodiments, a structured light projector and an nonstructured light projector may be spaced far enough apart that light pattern 120B only partially overlaps with a field of illumination of nonstructured light projector and only illuminates a portion of an imaged object (e.g., tooth 130).

Additionally, or alternatively to spacing a structured light projector further from an nonstructured light projector (e.g., to reduce overlap of their respective fields of illumination), the relative angles of the structured light projector and nonstructured light projector may be configured to cause their respective fields of illumination to be spaced further apart. For example, if the structured light projector and nonstructured light projector are angled away from each other, then a spacing between their fields of illumination may be increased.

Other techniques for reducing interference between light projectors may also be applied, as discussed in U.S. Application No. 63/656,524, filed Jun. 5, 2024, which is incorporated by reference herein in its entirety. The interference reduction techniques of U.S. Application No. 63/656,524 are discussed with reference to reducing interference between projections of multiple structured light projectors. However, one or more of these techniques may be adopted to reduce interference between a projected structured light and a projected nonstructured light in embodiments herein.

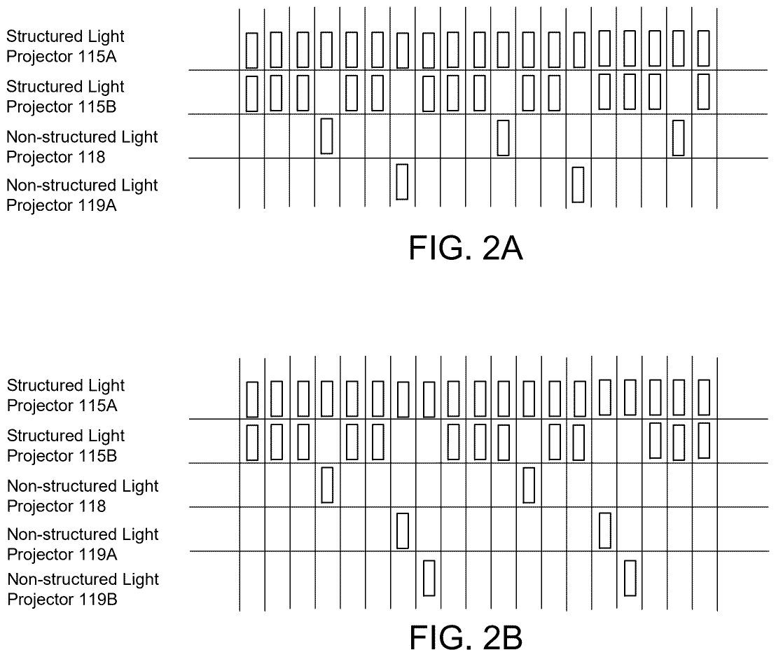

FIGS. 2A-B are timing diagrams showing the timing of light projection by various light projectors of an intraoral scanner, in accordance with one embodiment. Each of the timing diagrams is divided into rows and columns. Each column represents an exposure window or time (e.g., a frame) of capture of images by image sensors of the intraoral scanner's cameras. Each of the rows represents a different light projector. Each cell represents an exposure window for a particular light projector. Rectangles in cells indicate that a pulse of light was output by a particular light projector for a particular exposure window or frame. Note that the size of the rectangles relative to the size of the cells is not intended to be to scale. For example, the size of a cell does not necessarily indicate an exposure window duration and a size of a rectangle in a cell does not necessarily indicate a pulse/illumination time of a light projector. In embodiments the actual pulse time would likely be considerably shorter than the exposure window to avoid motion smearing. For example, if images are captured at 50 frames per second, then each exposure window may be 20 milliseconds and each pulse/illumination time may be about 2 milliseconds. Note that the rectangles are all shown with uniform size. However, different light projectors may use different pulse/illumination times. For example, uniform/smooth light illumination may be projected with a pulse width of 2 milliseconds, while structured light illumination may be projected with a pulse width of 1 millisecond.

In some embodiments, a positioning algorithm will take into account the center of a pulse of light as the pulse time. In one embodiment, the centers of the pulses of multiple different light projectors are aligned. Accordingly, if different projectors have different pulse widths, then the timing of when each of the light projectors emits a light pulse may be different from one another. For example, if structured illumination is projected with a 1 millisecond pulse and non-structured illumination is projected with a 2 millisecond pulse, then the non-structured illumination pulse may begin before the structured illumination pulse begins. If the pulse centers of multiple light projectors are not aligned (for example, if light projectors having different pulse widths start together), the positioning algorithm can take this into account when finding the exact position of the structured light vs the uniform light. In an example, a position difference may be determined based on the equation D=T×V, wherein D is the position difference, T=time difference between the pulse centers and V=relative speed between the intraoral scanner and an object being scanned.

Note that the timing diagrams show concurrent projection of light by multiple light projectors in any given frame (e.g., in any given column of the timing diagram). It should be understood that as used herein the term “concurrent projection” means projection of light in the same frame or exposure window. Accordingly, the light from different light projectors may be emitted at the same time or at different times and still be considered to be concurrent in the context of the present application so long as the light projection all occurs within a same exposure window.

In the timing diagram of FIG. 2A, an intraoral scanner alternates between projection of a structured light pattern, an nonstructured white light, and an nonstructured infrared light. As shown, in a first three frames multiple structured light projectors 115A-B output first structured light onto an intraoral object, which may be simultaneously captured by multiple cameras to generate an image set usable to generate a 3D point cloud (e.g., to generate an intraoral scan). The 3D point clouds generated at each of the first through third frames may be registered and stitched together to form a 3D surface.

In a fourth frame, a single light projector 115A outputs second structured light while a non-structured light projector 118 (e.g., a white light projector) outputs first nonstructured light. This may be captured by multiple cameras to generate an additional set of images that may each include a structured light portion and an nonstructured light portion. The structured light portion may be separated from the nonstructured light portion. The structured light portion may be used to generate a small 3D point cloud, which may be registered and/or stitched to the 3D surface (e.g., to add further data points to the 3D surface). Additionally, the structured light portion may be used to register the nonstructured light portion with the 3D surface. This may be performed based on the registration of the 3D point could to the 3D surface and a knowledge that the structured light portion and the nonstructured light portion share a common position and orientation. Data from the nonstructured light portion may accordingly be added to the 3D surface (e.g., as a texture) with high accuracy.

In frames five and six, the multiple structured light projectors 115A-B again output the first structured light onto the intraoral object, which may again be simultaneously captured by multiple cameras to generate an image set usable to generate a 3D point cloud (e.g., to generate an intraoral scan) for each frame. The 3D point clouds generated at each of the fifth and sixth frames may be registered and stitched to the 3D surface to add further data to the 3D surface. In some embodiments, since there is 3D data that was acquired at the fourth frame (e.g., from the structured light portion of the images captured at the fourth frame), this information can be used to improve a stitching of the 3D point cloud generated at the fifth frame to the 3D cloud generated at the third frame and/or to the 3D surface. The 3D point cloud generated at the fourth frame may have overlap with the 3D point cloud generated at the fifth frame, and may include some surface information that was not included in the 3D point cloud generated at the third frame. This increased amount of feature overlap increases an accuracy of registration and stitching in embodiments.

At frame seven, a single light projector 115A outputs the second structured light while a non-structured light projector 119A (e.g., an infrared/NIRI light projector) outputs second nonstructured light. Alternatively, a different single light projector 115B might output a third structured light commensurate with nonstructured light projector 119A outputting nonstructured light. The projected light may be captured by multiple cameras to generate an additional set of images that may each include a structured light portion and an nonstructured light portion. The structured light portion may be separated from the nonstructured light portion. The structured light portion may be used to generate a small 3D point cloud, which may be registered and/or stitched to the 3D surface (e.g., to add further data points to the 3D surface). Additionally, the structured light portion may be used to register the nonstructured light portion with the 3D surface. This may be performed based on the registration of the 3D point could to the 3D surface and a knowledge that the structured light portion and the nonstructured light portion share a common position and orientation. Data from the nonstructured light portion may accordingly be added to the 3D surface (e.g., as a texture) with high accuracy.

The sequence of which light projectors to use may continue along the same pattern in embodiments.

In the timing diagram of FIG. 2B, an intraoral scanner alternates between projection of a structured light pattern, an nonstructured white light, and a first nonstructured infrared light, and a second nonstructured infrared light. In embodiments, it can be advantageous to capture infrared images of a tooth using infrared illumination from different angles. Each illumination from a different angle may provide information on different features or portions of the tooth. The images generated based on illumination from different angles may then be combined to generate a blended infrared image that has improved contrast and additional information as compared to a single infrared image taken with one lighting configuration. Such an illumination scheme is described in U.S. application Ser. No. 17/896,698, filed Jul. 20, 2022, which is incorporated by reference herein in its entirety.

In order for the blended image to have a highest possible accuracy, it is beneficial for the infrared images generated using illumination from different angles to be captured close together in time so that they essentially image the same object from the same position and orientation. However, this causes there to be multiple concurrent frames for which structured light projection might not be used. By introducing concurrent structured light and nonstructured light illumination, multiple infrared images may be captured in succession without reducing a quality and accuracy of registration and stitching between 3D point clouds generated from frames taken before infrared imaging and 3D point clouds generated from frames taken after infrared imaging.

The timing diagram of FIG. 2B deviates from the timing diagram of FIG. 2A in that rather than using a single non-structured light projector 119A for infrared imaging (or multiple nonstructured light projectors projecting at a same time), nonstructured light projector 119A and nonstructured light projector 119B are both used for infrared imaging at different frames. In the illustrated example, a same structured light projector 115A is used during both the seventh and eighth frames (e.g., structured light projector 115A and nonstructured light projector 119A are used together at frame seven and structured light projector 115A and nonstructured light projector 119B are used together at frame eight). However, in some embodiments, different structured light projectors may be used in conjunction with different nonstructured light projectors. For example, structured light projector 115B may be used with nonstructured light projector 119A, while structured light projector 115A may be used with nonstructured light projector 119B. In some embodiments, a structured light projector that is furthest from nonstructured light projector 119A is chosen for concurrent use with nonstructured light projector 119A. Similarly, a structured light projector that is furthest from nonstructured light projector 119B may be chosen for concurrent use with nonstructured light projector 119B. The infrared images generated using the different illumination may be processed to separate a structured light portion from an nonstructured light portion for each frame. The nonstructured light portions of the images generated at the different frames (e.g., at frames seven and eight) may then be combined to generate a blended infrared image using the techniques described in U.S. application Ser. No. 17/896,698. The structured light portions of the two frames may then be used to register the blended infrared image to the 3D surface and to add additional information to the 3D surface (e.g., to augment the 3D surface) in embodiments.

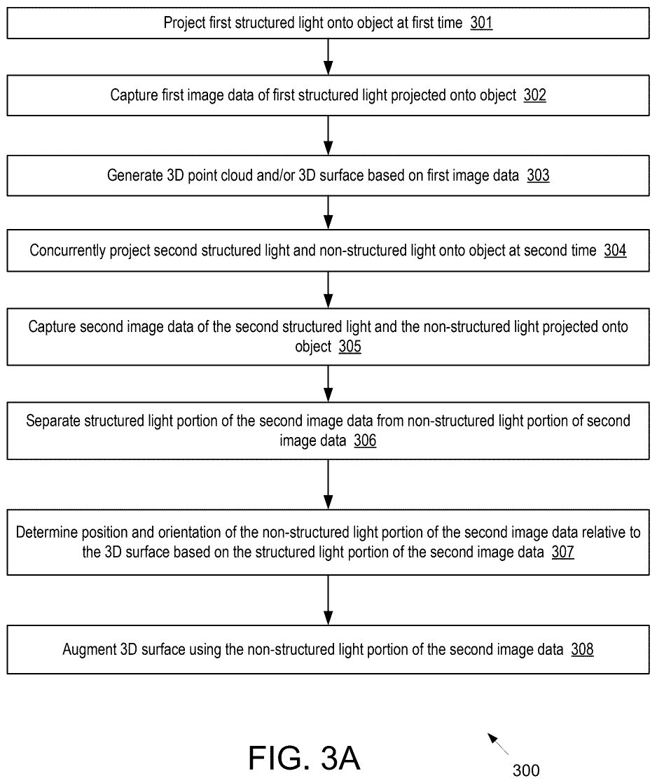

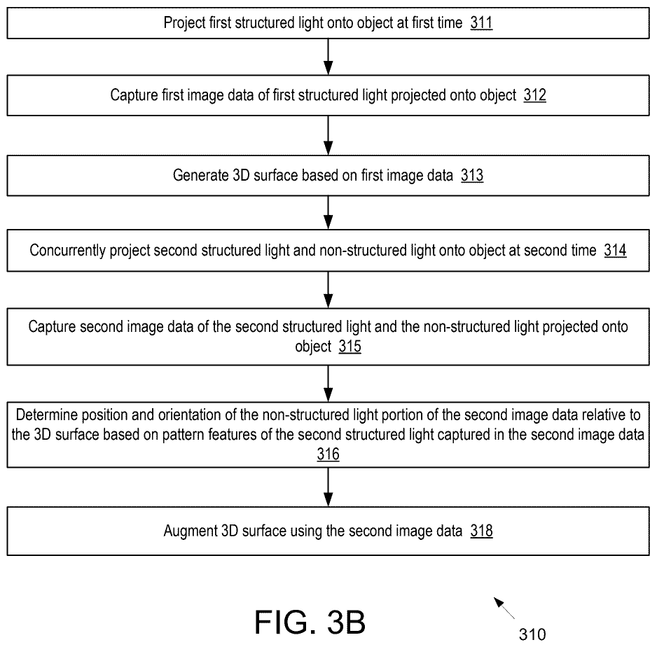

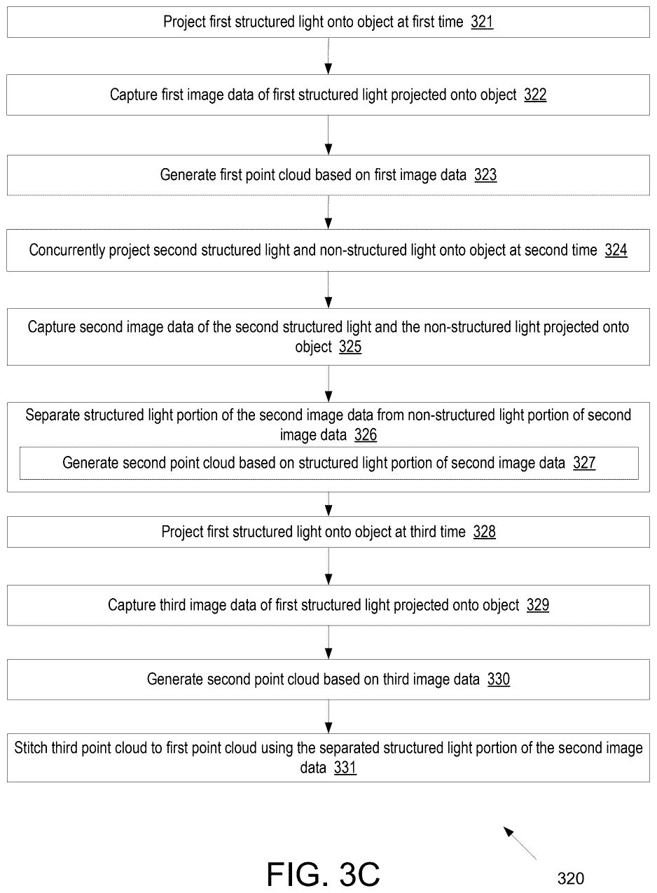

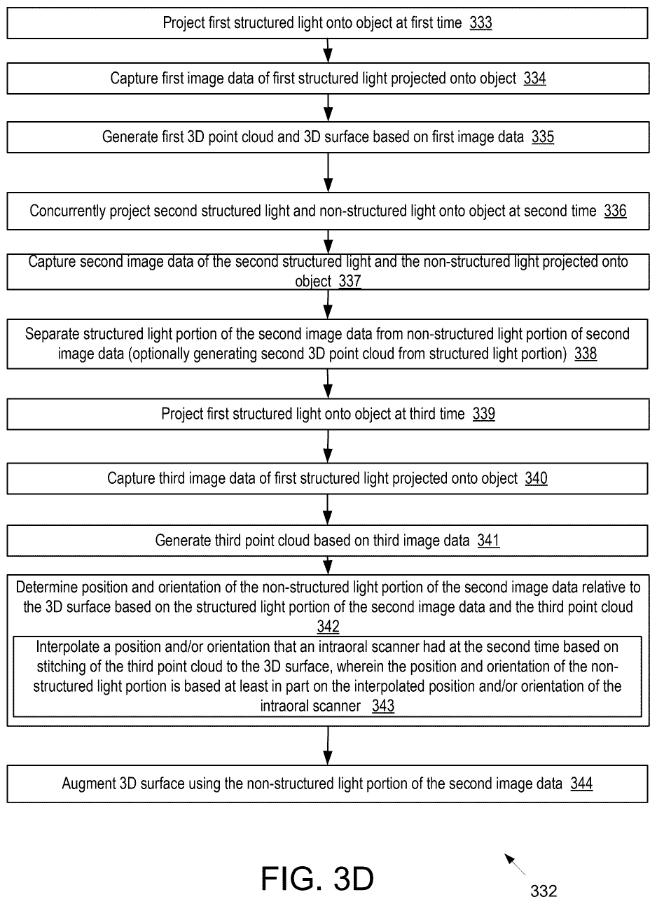

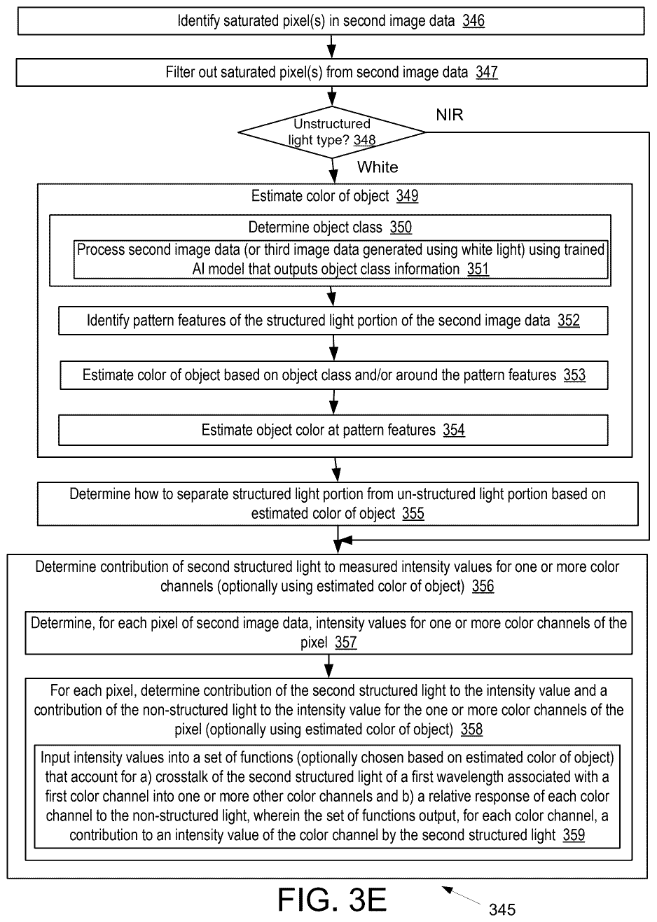

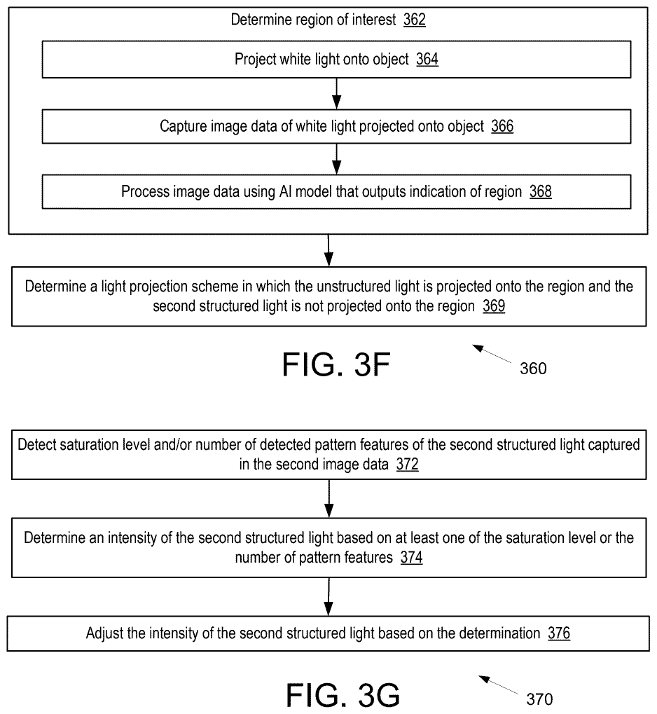

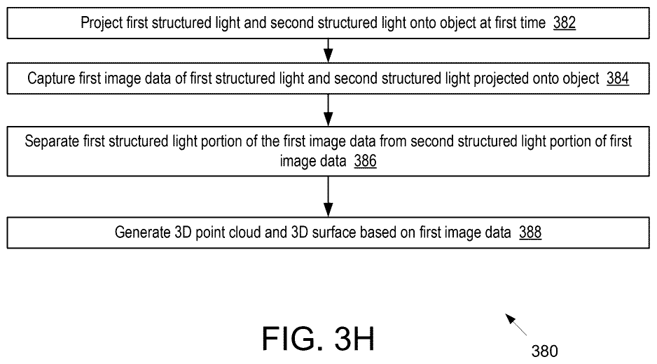

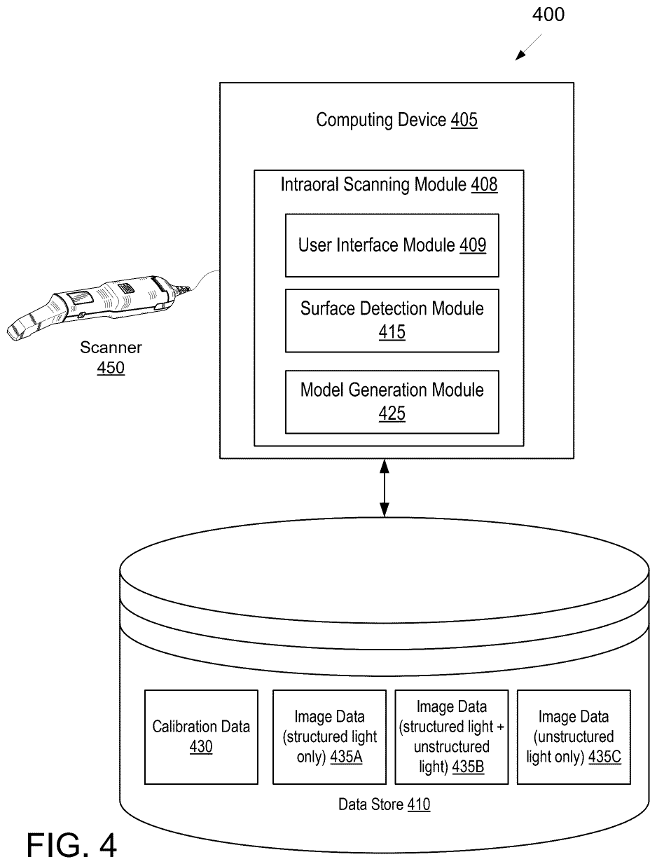

FIGS. 3A-G illustrate methods for using concurrently projected structured light and nonstructured light to augment a 3D surface generated using structured light projection, in accordance with embodiments of the present disclosure. The methods of FIGS. 3A-G may be performed by processing logic that comprises hardware (e.g., circuitry, dedicated logic, programmable logic, microcode, etc.), software (such as instructions run on a processing device), or a combination thereof. In one embodiment, processing logic corresponds to computing device 405 of FIG. 4. In some embodiments, some aspects of the methods may be performed by an intraoral scanner (e.g., scanner 450 of FIG. 4), while other aspects of the methods are performed by a computing device that may be operatively coupled to an intraoral scanner (e.g., computing device 405 of FIG. 4). The computing device may be a local computing device that is connected to the intraoral scanner via a wired connection or via a wireless connection. Alternatively, the computing device may be a remote computing device that connects via a network (e.g., the Internet and/or an intranet) to the intraoral scanner or to a local computing device that is in turn connected to the intraoral scanner.

FIG. 3A illustrates a flow diagram for a method 300 of using concurrently projected structured light and nonstructured light to augment a 3D surface generated using structured light projection, in accordance with embodiments of the present disclosure.

At block 301 of method 300, processing logic causes one or more structured light projectors of an intraoral scanner to project first structured light (e.g., a first light pattern comprising first pattern features) onto an object (e.g., an intraoral object such as a tooth, gingiva, etc.). The structured light projector(s) may project coherent light and/or non-coherent (e.g., white) light. The processing logic may be processing logic of the intraoral scanner and/or of a computing device connected to the intraoral scanner over a wired or wireless connection.

At block 302, processing logic causes cameras of the intraoral scanner to capture first image data of the first structured light projected onto the object. For example, the cameras may image the object illuminated by the projected first light pattern to produce first intraoral scan data. If non-coherent light is projected, then generated images may be color images, and illuminated parts of the patterns may be used to determine color of the scanned surface. The intraoral scanner may include a plurality of cameras that capture images of the object illuminated by the projected first structured light.

First image data (also referred to as a first intraoral scan or first intraoral scan data) may include a set of images generated at a same time or approximately the same time, each image having been generated by a different camera. Other intraoral scans may also be received, each including a set of images captured at a different time during illumination of the object by the first structured light. Each intraoral scan may include image data generated by multiple cameras of an intraoral scanner. In an example, two or more cameras of an intraoral scanner may each generate an intraoral image, and the multiple intraoral images may be combined based on the known positions and orientations of the respective two or more cameras to form an intraoral scan (e.g., image data). In one embodiment, each intraoral scan may include captured image features that correspond to pattern features that were projected onto a region of the object (e.g., a dental site) by one or more structured light projectors. Image features as used herein are features of a light pattern that are captured in an image (as opposed to pattern features, which are features of a projected light pattern as projected). Image features correspond to camera rays, while pattern features correspond to projector rays. For example, one or more structured light projectors may be driven to project a distribution of discrete unconnected spots of light or a checkerboard pattern on an intraoral surface, and the cameras may be driven to capture images of the projection. The image captured by each camera may include image features corresponding to at least one of the pattern features (e.g., projected spots, features of a checkerboard pattern, etc.). Together the images generated by the various cameras at a particular time may form an intraoral scan (e.g., first intraoral scan data or first image data).

Each camera may include a camera sensor that has an array of pixels, for each of which there exists a corresponding ray in 3D space originating from the pixel whose direction is towards an object being imaged; each point along a particular one of these rays, when imaged on the sensor, will fall on its corresponding respective pixel on the sensor. As used throughout this application, the term used for this is a “camera ray.” Similarly, for each projected spot or other feature from each projector there exists a corresponding projector ray. Each projector ray corresponds to a respective path of pixels on at least one of the camera sensors, i.e., if a camera sees a spot projected by a specific projector ray, that spot will necessarily be detected by a pixel on the specific path of pixels that corresponds to that specific projector ray. Values for (a) the camera ray corresponding to each pixel on the camera sensor of each of the cameras, and (b) the projector ray corresponding to each of the projected pattern features from each of the projectors, may be stored as calibration data, as described hereinbelow.

At block 303, processing logic generates a 3D surface based on the first image data. In one embodiment, processing logic runs a correspondence algorithm to determine 3D points in space for captured image features and to generate a point cloud from the image data. The first image data may include one or more images from different cameras, wherein the images of the different cameras may have been generated at the same time and may constitute an image set in embodiments. Running the correspondence algorithm may include, for each set of images, determining a correspondence between pattern features in the first pattern of light (e.g., first structured light) in the set of images by determining intersections of projector rays corresponding to one or more of the first pattern features a with camera rays corresponding to the one or more image features in three-dimensional (3D) space based on calibration data that associates the camera rays corresponding to pixels on the camera sensor of each of the two or more cameras to the projector rays. Running the correspondence algorithm may include first determining the correspondence between the pattern features and the image features in the 3D space for a first subset of the pattern features that are associated with a highest number of image features. The pattern features in the first subset may include first pattern features from the first light projector and/or second pattern features from the second light projector. Once correspondences have been found for the first subset of the pattern features that are associated with a highest number of image features, processing logic may subsequently determine the correspondence between the pattern features and the image features in the 3D space for a second subset of the pattern features that are associated with a next highest number of image features. This process may be repeated, each time for pattern features associated with a next highest number of image features.

Processing logic may determine depths associated with pattern features based on correspondence to image features in one or more images. The depths may be combined with x,y information also determined from the images to determine 3D coordinates of the image features, and thus 3D coordinates of points on a scanned intraoral surface. The depths may be determined using a correspondence algorithm and stored calibration values. The stored calibration values may associate camera rays corresponding to pixels on a camera sensor of each of a plurality of cameras to a plurality of projector rays.

Processing logic may run the correspondence algorithm using the stored calibration values in order to identify a three-dimensional location for each projected point or feature (referred to as a pattern feature) on a surface of a scanned object. In one embodiment, for a given projector ray, the processor “looks” at the corresponding camera sensor path on one of the cameras. Each detected image feature along that camera sensor path will have a camera ray that intersects the given projector ray (and thus the pattern feature). That intersection defines a three-dimensional point in space. The processor may search among the camera sensor paths that correspond to that given projector ray on the other cameras and may identify how many other cameras, on their respective camera sensor paths corresponding to the given projector ray, also detected an image feature whose camera ray intersects with that three-dimensional point in space. As used herein throughout the present application, if two or more cameras detect image features whose respective camera rays intersect a given projector ray at the same three-dimensional point in space, the cameras are considered to “agree” on the image feature and/or pattern feature being located at that three-dimensional point. Accordingly, the processor may identify three-dimensional locations of the projected pattern of light based on agreements of the two or more cameras on there being the projected pattern of light by projector rays at certain intersections. The process is repeated for the additional image features along a camera sensor path, and the image feature for which the highest number of cameras “agree” is identified as the image feature that is being projected onto the surface from the given projector ray (and thus that corresponds to a particular pattern feature). A three-dimensional position on the surface is thus computed for that image feature, including the depth for that image feature. Accordingly, a depth of a first intraoral 3D surface may be determined (which may include depths of multiple different points on the surface of the first intraoral 3D surface).

Once a position on the surface is determined for a specific image feature, the projector ray that projected that image feature, as well as all camera rays corresponding to that image feature, may be removed from consideration and the correspondence algorithm may be run again for a next projector ray. This may be repeated until depths are determined for many or all image features (or there are no remaining image features for which a solution can be found with a threshold level of confidence).

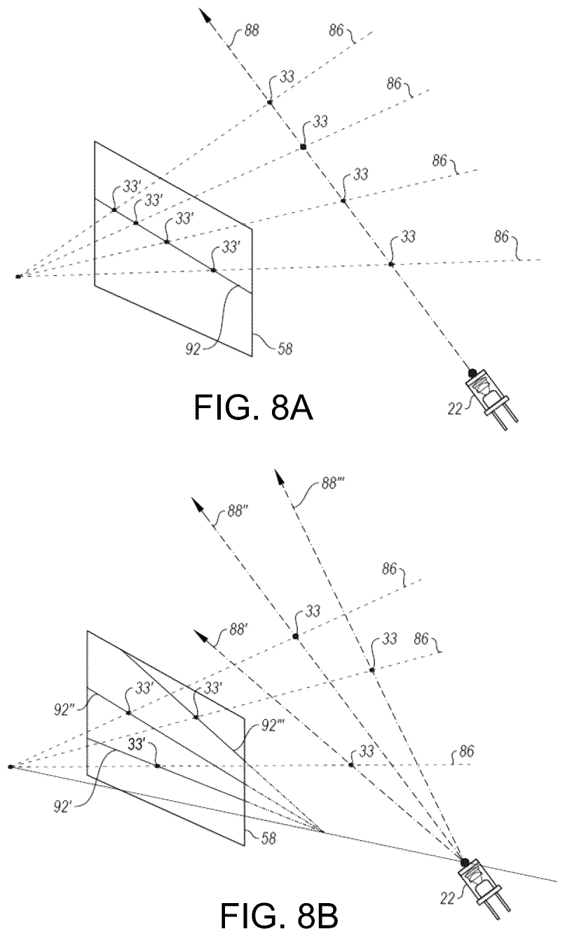

Ultimately, the identified three-dimensional locations may be used to generate a digital three-dimensional surface and/or a 3D model of the scanned object. For example, processing logic may generate a digital 3D representation or surface of a dental object based on the determined correspondence between the pattern features and the image features in the one or more sets of images captured during projection of the first structured light onto the object. The correspondence algorithm for solving for correspondence between pattern features (e.g., corresponding to projector rays from one or more light projectors) and image features (e.g., corresponding to camera rays from one or more cameras) is described in greater detail below with reference to FIGS. 8A-19.

Processing logic may stitch together the plurality of intraoral scans (e.g., 3D point cloud generated from image data captured at different times using the first structured light). This may include registering a first intraoral scan to one or more additional intraoral scans using overlapping data between the various intraoral scans. In one embodiment, performing scan registration includes capturing 3D data of various points of a surface in multiple intraoral scans, and registering the intraoral scans by computing transformations between the intraoral scans. The intraoral scans may then be integrated into a common reference frame by applying appropriate transformations to points of each registered intraoral scan.

In one embodiment, surface registration is performed for adjacent or overlapping intraoral scans (e.g., successive frames of an intraoral video). Surface registration algorithms are carried out to register two or more intraoral scans that have overlapping scan data, which essentially involves determination of the transformations which align one scan with the other. Surface registration may be performed using, for example, an iterative closest point (ICP) algorithm, and may involve identifying multiple points in multiple scans (e.g., point clouds), surface fitting to the points of each scan, and using local searches around points to match points of the overlapping scans. Some examples of ICP algorithms that may be used are described in Francois Pomerleau, et al., “Comparing ICP Variants on Real-World Data Sets”, 2013, which is incorporated by reference herein. Other techniques that may be used for registration include those based on determining point-to-point correspondences using other features and minimization of point-to-surface distances, for example. In one embodiment, scan registration (and stitching) is performed as described in U.S. Pat. No. 6,542,249, issued Apr. 1, 2003, entitled “Three-dimensional Measurement Method and Apparatus,” which is incorporated by reference herein. Other scan registration techniques may also be used.

Surface registration may include both stitching pairs of intraoral scans sequentially, as well as performing a global optimization that minimizes all pairs of positions together and/or or minimizes all points from all scans one to another. Accordingly, if a scan to scan registration (e.g., using ICP) searches in 6 degrees of freedom (3 translation and 3 rotation) that optimizes the distance of all points from one scan to another, then a global optimization of 11 scans will search in (11−1)×6=60 degrees of freedom for all scans relative to all other scans, while minimizing some distance between all scans. In some cases, this global optimization should give weights to different errors (e.g., edges of scans and/or far points may be given lower weight for better robustness).

A special condition may arise when features (e.g., lines or points) that are less than a surface are to be registered to a surface. Assume that in one scan a feature point of a surface (e.g., a corner of a scan body) is captured, and in another scan the surface that includes the feature/point is captured. In the ICP, distance between points from one surface to another are minimized, but the point correspondence step of the ICP can change in each iteration. In a variant algorithm, a fixed correspondence may be found between the feature/point (e.g., of a feature of a surface) and the surface points (e.g., of a surface), and try to minimize it together with all the surface minimization. As the feature may be a single point or a few points, and may be overwhelmed by the majority of surface points, the error of this feature point will receive a high weight in the global error.

Processing logic may generate a 3D surface (e.g., virtual 3D model) of the dental arch from the intraoral scans by integrating data from all intraoral scans (e.g., different image data generated at different times during scanning) into a single 3D surface or model by applying the appropriate determined transformations to each of the scans/image data. Each transformation may include rotations about one to three axes and translations within one to three planes, for example.

At block 304, processing logic causes the one or more structured light projectors, or a subset of the one or more structured light projectors, to project second structured light (e.g., a second light pattern comprising second pattern features) onto the object (e.g., a dental site (e.g., an oral structure, dental arch, tooth, etc.). Processing logic additionally causes one or more non-structured light projectors to project nonstructured light onto the object concurrent to the second structured light being projected onto the object. The second structured light may be a subset of the first structured light in some embodiments. In some embodiments, the first structured light is projected by a plurality of structured light projectors, and the second structured light is projected by a subset of the plurality of structured light projectors (e.g., by a single structured light projector). The second structured light may include fewer pattern features (e.g., fewer spots, lines, squares, etc.) than the first structured light. In an example, the first structured light may include hundreds to thousands of pattern features, and the second structured light may include about 5-50 pattern features, such as 9 pattern features, 12 pattern features, 15 pattern features, 18 pattern features, 20 pattern features, 24 pattern features, and so on. In some embodiments, the second structured light is coherent light having a particular wavelength, and the first structured light is coherent light from multiple light sources, where different light sources may project coherent light having a different color. For example, the first structured light may include blue pattern features and green pattern features, and the second structured light may include just blue pattern features.

In some embodiments, the nonstructured light has a particular wavelength (e.g., is coherent light). Alternatively, the nonstructured light may be noncoherent light, such as white light. In some embodiments, the nonstructured light is produced by one or more near-infrared light projectors that project near-infrared and/or infrared light onto the object while the object is being scanned. At least one camera captures images of the object using illumination from the near-infrared light projector(s).

At block 305, processing logic causes the cameras of the intraoral scanner to capture second image data of the second structured light and the nonstructured light concurrently projected onto the object. For example, the cameras may image the object illuminated by a projected second light pattern and the nonstructured light to produce second image data. Second image data may include a second set of images generated at a same time or approximately the same time, each image having been generated by a different camera.

At block 306, processing logic may separate a structured light portion of the second image data from a non-structured light portion of the second image data. The structured light portion of the second image data may include portions of captured intensity values of one or more pixels that are attributable to the second structured light. The nonstructured light portion of the second image data may include portions of captured intensity values of the one or more pixels that are attributable to the nonstructured light. The amount of contribution of the nonstructured light portion and of the structured light portion to a measured intensity value of a pixel may vary from pixel to pixel in embodiments. For example, pixels capturing a feature of the structured light may have a greater contribution to a measured intensity value than pixels not capturing a feature of the structured light. In some embodiments, the structured light may have a known wavelength, and there may be a known or calibrated response of pixels to the structured light of the known wavelength. For example, an image sensor may include a color filter such as a Bayer color filter, and there may be a known amount of light from the wavelength of the structured light that passes through the blue, green and red filters of the color filter (e.g., the Bayer filter). For example, if the structured light is blue light, then 100% of the light may pass the blue filter, and some fraction of the light may pass through the red and green filters. Similarly, in some embodiments the nonstructured light has a known wavelength. For example, the nonstructured light may be infrared light having a known wavelength. An amount of the infrared light that passes through filters of one or more pixels of the image sensor may be known. Some embodiments are described with reference to a Bayer filter. However, it should be understood that the embodiments discussed herein work equally well with other types of filters as well. For example, filters such as a CYGM (cyan, yellow, green, magenta) filter, an RGBE (red, green, blue, emerald) filter, a Foveon X3 sensor, an RGBIR filter, and so on may be used in embodiments. In some embodiments, the image sensors include an RGBIR filter. In such a filter the IR filters may pass 100% of the IR light, and the R, G and B filters may pass some known or calibrated fraction of the IR light. Based on such known information, a contribution of the structured light and of the nonstructured light to measured intensity values of various pixels may be determined. These contributions may be separated out to generate a structured light portion image based on the structured light portion of the second image data and an nonstructured light portion image based on the nonstructured light portion of the second image data.

In some embodiments, the structured light portion and the nonstructured light portion are separated using the technique described with reference to FIG. 3E. In some embodiments, the structured light portion is separated from the nonstructured light portion using a trained artificial intelligence (AI) model, such as a trained machine learning (ML) model. For example, a neural network may be used. The second image data, or a portion of the second image data (e.g., a small pixel region of an image of the second image data) may be input into an AI model. In some embodiments, a trained machine learning model operates on image patches rather than full images captured by cameras. The image patches may be small pixel regions in embodiments. The small pixel region may be, for example, a 3×3 pixel region, a 5×5 pixel region, a 7×7 pixel region, a 10×10 pixel region, a 20×20 pixel region, or other size pixel region. Images may be divided into smaller pixel regions, and each pixel region may be processed separately by the machine learning model. If smaller pixel regions are processed at a time, this enables the machine learning model to be smaller and simpler. This may be advantageous, for example, for a machine learning model that runs on a processor of the intraoral scanner. In one example, the machine learning model includes one or a few small neural networks (e.g., such as neural networks having a U-net architecture). In embodiments, one neural network may be used to identify a structured light portion of a captured image and one neural net may be used to identify a non-structured light portion of the captured image. In one embodiment, the multiple neural networks may share one or more layers (e.g., an input layer and/or one or more other lower level layers). The neural network(s) may output separation information, indicating intensity contributions of the nonstructured light and of the structured light to each pixel of the input image data. In one embodiment, the structured light focused neural network outputs a structured light image and the non-structured light focused neural network outputs a non-structured light image based on an input of a combined image that was captured using concurrently projected structured light and non-structured light.

In some embodiments entire images are input into the AI model. The AI model may then output separation information, indicating intensity contributions of the nonstructured light and of the structured light to each pixel of the input image data.

In embodiments, the AI model may be trained using sets of mixed images (including an overlay of an image of an object using structured light and an image of the same object from the same camera position using nonstructured light) as inputs, and separate images as target outputs. Such training data can be created by scanning objects on a jig that moves in a controlled manner. Each image modality (e.g., structured light image and nonstructured light image) may be captured separately. Combined images may then be synthesized by adding the images captured using the different image modalities together. Alternatively, additional images may be captured under combined lighting conditions (e.g., with concurrently projected structured light and nonstructured light).

At block 307, processing logic determines a position and orientation of the non-structured light portion of the second image data relative to the 3D surface based on the structured light portion of the second image data. The structured light portion of the second image data and the non-structured light portion of the second image data are from the same set of images, and thus reflect the same position and orientation of the cameras (and the intraoral scanner) relative to the imaged object as one another. Once the light portions are separated, the structured light portion of the second image data may be processed to generate a 3D point cloud using the same technique as described above at block 303. The 3D point cloud may then be registered to the 3D surface (e.g., to the point cloud generated at block 303). Such registration provides 3D coordinates, rotations, translations, etc. for the structured light portion of the second image data that accurately merges the structured light portion of the second image data with the 3D surface. Since the structured light portion of the second image data and the nonstructured light portion of second image data have the same image plane(s) and are drawn from the same image(s), the registration of the structured light portion of the second image data also applies to the nonstructured light portion of the second image data. Accordingly, once the structured light portion of the second image data is successfully registered to the 3D surface, the position and orientation of the nonstructured light portion of the second image data relative to the 3D surface is determined.

At block 308, processing logic augments the 3D surface using the nonstructured light portion of the second image data. This may include adding information from the nonstructured light portion of the second image data to the 3D surface. For example, the nonstructured light portion of the second image data may be added to the 3D surface as a texture. In some embodiments, processing logic also augments the 3D surface using the structured light portion of the second image data. For example, the determined 3D point cloud (determined from the structured light portion of the second image data) may be stitched to the 3D surface to add additional data points to the 3D surface. The added data points may be data points that can then be used when registering additional point clouds generated at subsequent times during intraoral scanning, improving an accuracy of registering those future 3D point clouds to the 3D surface.

Due to a smaller point cloud that is generated from the second image data than is generated from the first image data, a different registration and/or stitching procedure may be used for the point cloud generated from the second image data than is used for the point cloud generated from the first image data. For example, immediate stitching may be delayed until both before and after point clouds are collected using the first structured light pattern. For example, the operations of blocks 301-303 may be performed a second time after operations of blocks 304-306, and the 3D point clouds generated from the iterations of block 303 before the second image data is captured and after the second image data is captured may be used together to assist in determining the position and orientation of the non-structured light portion of the second image data (e.g., for stitching of the structured light portion of the second image data to the 3D surface and/or point clouds). Some parameters may be modified between registration/stitching performed using 3D point clouds generated from the first structured light and 3D points clouds generated from the second structured light. For example, regular stitching may be followed by an overlap grading mechanism that checks how many points were used and decides if enough points were found. This grading may be re-optimized to the smaller point cloud for stitching of points clouds generated using the second image data in embodiments.

In embodiments, the second image data that includes both the structured light portion and the nonstructured light portion provides improved determination of a position and/or orientation of the intraoral scanner wand, cameras of the intraoral scanner and/or image(s) for nonstructured light image data. This improved position information may be used to improve an accuracy of texture mapping, SLAM, NIRI image blending, interproximal space determination, mapping of 2D information to 3D information, and any other uniform or smooth illumination processing of the 3D object in embodiments.

Some methods of positioning the 2D uniform or smooth illumination images relative to the 3D surface were described in U.S. application Ser. No. 18/645,346. The methods described herein can work independently or together with the techniques set forth in U.S. application Ser. No. 18/645,346. For example, the structured light illumination can be used to give an initial position estimate, which may then be used in the techniques described in U.S. application Ser. No. 18/645,346. It can be simpler and/or quicker to compute 3D position of the nonstructured light portion of the image using the techniques described herein than using the techniques described in the referenced applications, but may provide reduced accuracy in some embodiments. A decision of which technique (or combination of techniques) to use can be made depending on a needed accuracy level. In some embodiments, when using both methods, an optimization procedure can optimize both the uniform/smooth illumination methods and the structured stitching methods at the same time and arrive at a more precise localization. In some cases, a limit on a number of illumination drivers may cause the two-light pulse of concurrent structured light and nonstructured light to be given at slightly different timing. In such instances, processing logic can compensate for a small motion of the intraoral scanner between projection of the structured light and the nonstructured light by an estimate of the velocity of the intraoral scanner.

In some embodiments, the nonstructured light portion of the second image data is processed using one or more trained machine learning models to determine information about the imaged object. The second image data may be input into the one or more ML models, which may output, for example, segmentation information segmenting the image(s) into teeth, gingiva, etc. The one or more ML models may additionally output identifications of one or more types of oral conditions (e.g., oral health problems), such as caries, gingival swelling, tooth cracks, and so on. In some embodiments, the one or more ML models output segmentation information for and/or bounding boxes around one or more identified oral conditions. In some embodiments, processing logic processes the nonstructured light portion of the second image data by applying the techniques set forth in U.S. application Ser. No. 17/564,115, filed Dec. 28, 2021, which is incorporated by reference herein in its entirety.

In some embodiments, method 300 may be repeated one or more times until a 3D surface provides a complete and accurate representation of a dental site (e.g., of an upper and/or lower jaw of a patient). Different iterations of method 300 may be performed using different types of nonstructured light at blocks 304 and 305. For example, the nonstructured light may be infrared light in a first iteration of method 300, and the nonstructured light may be white light in a second iteration of method 300. In some embodiments, operations of blocks 301-306 are performed at an intraoral scanner (e.g., by a processor of an intraoral scanner wand) and operations of blocks 307-308 may be performed at a computing device connected to the intraoral scanner by a wired or wireless connection. If a wireless intraoral scanner is used, the image data will usually be compressed before wirelessly sending the image data to a computing device, which may be a lossy compression. Accordingly, by performing the operations of blocks 301-306 on the intraoral scanner, the accuracy of the separation of the structured light portion from the nonstructured light portion may be improved. Alternatively, the operations of one or more of blocks 301-306 may be performed on the computing device.

FIG. 3B illustrates a flow diagram for a method 310 of using concurrently projected structured light and nonstructured light to augment a 3D surface generated using structured light projection, in accordance with embodiments of the present disclosure.

At block 311 of method 310, processing logic causes one or more structured light projectors of an intraoral scanner to project first structured light (e.g., a first light pattern comprising first pattern features) onto an object (e.g., an intraoral object such as a tooth, gingiva, etc.). At block 312, processing logic causes cameras of the intraoral scanner to capture first image data of the first structured light projected onto the object. At block 313, processing logic generates a 3D surface based on the first image data.

At block 314, processing logic causes the one or more structured light projectors, or a subset of the one or more structured light projectors, to project second structured light (e.g., a second light pattern comprising second pattern features) onto the object (e.g., a dental site (e.g., an oral structure, dental arch, tooth, etc.). Processing logic additionally causes one or more non-structured light projectors to project nonstructured light onto the object concurrent to the second structured light being projected onto the object. The second structured light may be a subset of the first structured light in some embodiments or may be the same as the first structured light in some embodiments. At block 315, processing logic causes the cameras of the intraoral scanner to capture second image data of the second structured light and the nonstructured light concurrently projected onto the object. For example, the cameras may image the object illuminated by a projected second light pattern and the nonstructured light to produce second image data. Second image may include a second set of images generated at a same time or approximately the same time, each image having been generated by a different camera.

At block 316, processing logic determines a position and orientation of the non-structured light portion of the second image data relative to the 3D surface based on the structured light portion of the second image data. In one embodiment, this involves first separating the structured light portion of the second image data from the nonstructured light portion of the second image data. Alternatively, the structured light portion of the second image data may not be separated from the nonstructured light portion of the second image data before determining the orientation of the nonstructured light portion of the second image data relative to the 3D surface.

At block 328, processing logic augments the 3D surface using the second image data. This may include augmenting the 3D surface using the nonstructured light portion of the second image data and/or using the structured light portion of the second image data.

In some embodiments, method 310 may be repeated one or more times until a 3D surface provides a complete and accurate representation of a dental site (e.g., of an upper and/or lower jaw of a patient). Different iterations of method 310 may be performed using different types of nonstructured light at blocks 314 and 315. For example, the nonstructured light may be infrared light in a first iteration of method 310, and the nonstructured light may be white light in a second iteration of method 310. In some embodiments, operations of block 311-315 are performed at an intraoral scanner (e.g., by a processor of an intraoral scanner wand) and operations of blocks 316-318 may be performed at a computing device connected to the intraoral scanner by a wired or wireless connection.

FIG. 3C illustrates a flow diagram for a method 320 of using concurrently projected structured light and nonstructured light to facilitate stitching between image data generated using structured light projection without nonstructured light projection, in accordance with embodiments of the present disclosure.

At block 321 of method 320, processing logic causes one or more structured light projectors of an intraoral scanner to project first structured light (e.g., a first light pattern comprising first pattern features) onto an object (e.g., an intraoral object such as a tooth, gingiva, etc.). At block 322, processing logic causes cameras of the intraoral scanner to capture first image data of the first structured light projected onto the object. At block 323, processing logic generates a first 3D point cloud based on the first image data using the techniques described herein. The first 3D point cloud may be registered and stitched to one or more other 3D point clouds also generated using image data of the first structured light projected onto the object at one or more earlier times during a current scanning session to generate a 3D surface.

At block 324, processing logic causes the one or more structured light projectors, or a subset of the one or more structured light projectors, to project second structured light (e.g., a second light pattern comprising second pattern features) onto the object (e.g., a dental site (e.g., an oral structure, dental arch, tooth, etc.). Processing logic additionally causes one or more non-structured light projectors to project nonstructured light onto the object concurrent to the second structured light being projected onto the object. The second structured light may be a subset of the first structured light in some embodiments. At block 325, processing logic causes the cameras of the intraoral scanner to capture second image data of the second structured light and the nonstructured light concurrently projected onto the object. For example, the cameras may image the object illuminated by a projected second light pattern and the nonstructured light to produce second image data. Second image may include a second set of images generated at a same time or approximately the same time, each image having been generated by a different camera.

At block 326, processing logic may separate a structured light portion of the second image data from a non-structured light portion of the second image data, as discussed above. In one embodiment, at block 327 processing logic may generate a second 3D point cloud from the structured light portion of the second image data using the techniques described herein. In embodiments, the second 3D point cloud generated from the structured light portion of the second image data may be registered and stitched to the earlier generated 3D point cloud and/or to an earlier generated 3D surface (e.g., to add additional data points to the 3D surface).

At block 328, processing logic causes the one or more structured light projectors to again project the first structured light onto the object. At block 329, processing logic causes the cameras of the intraoral scanner to capture third image data of the first structured light projected onto the object. At block 330, processing logic generates a third 3D point cloud based on the first image data using the techniques described herein.

At block 331, processing logic stitches the third 3D point cloud to the first 3D point cloud and/or to the 3D surface using the separated structured light portion of the second image data. This may include stitching the second 3D point cloud generated from the structured light portion of the second image data to the first 3D point cloud and stitching the third 3D point cloud to the second 3D point cloud of the structured light portion of the second image data. The first 3D point cloud and the third 3D point cloud may not have sufficient overlapping points or surface area for accurate registration and stitching. However, the second 3D point cloud generated from the structured light portion of the second image data may have overlap with both the first 3D point cloud and the third 3D point cloud since the second image data was captured in between capture of the first image data and the third image data. Accordingly, by registering and stitching the second 3D point cloud to the first 3D point cloud, a combined point cloud may be generated that has additional features that overlap with features of the third 3D point cloud, which improves a registration and stitching accuracy. Accordingly, by using some structured light projection during capture of white light images and/or NIRI images, the accuracy of registration and stitching of intraoral scans captured before such white light images/NIRI images are captured to intraoral scans captured after such white light images/NIRI images are captured is improved in embodiments.

FIG. 3D illustrates a flow diagram for a method 332 of using concurrently projected structured light and nonstructured light to augment a 3D surface generated using structured light projection, in accordance with embodiments of the present disclosure.

At block 333 of method 332, processing logic causes one or more structured light projectors of an intraoral scanner to project first structured light (e.g., a first light pattern comprising first pattern features) onto an object (e.g., an intraoral object such as a tooth, gingiva, etc.). At block 334, processing logic causes cameras of the intraoral scanner to capture first image data of the first structured light projected onto the object. At block 335, processing logic generates a first 3D point cloud based on the first image data using the techniques described herein. The first 3D point cloud may be registered and stitched to one or more other 3D point clouds also generated using image data of the first structured light projected onto the object at one or more earlier times during a current scanning session to generate a 3D surface.

At block 336, processing logic causes the one or more structured light projectors, or a subset of the one or more structured light projectors, to project second structured light (e.g., a second light pattern comprising second pattern features) onto the object (e.g., a dental site (e.g., an oral structure, dental arch, tooth, etc.). Processing logic additionally causes one or more non-structured light projectors to project nonstructured light onto the object concurrent to the second structured light being projected onto the object. The second structured light may be a subset of the first structured light in some embodiments. At block 337, processing logic causes the cameras of the intraoral scanner to capture second image data of the second structured light and the nonstructured light concurrently projected onto the object.

At block 338, processing logic may separate a structured light portion of the second image data from a non-structured light portion of the second image data, as discussed above. In one embodiment, at block 338 processing logic may generate a second 3D point cloud from the structured light portion of the second image data using the techniques described herein.

At block 339, processing logic causes the one or more structured light projectors to again project the first structured light onto the object. At block 340, processing logic causes the cameras of the intraoral scanner to capture third image data of the first structured light projected onto the object. At block 341, processing logic generates a third 3D point cloud based on the first image data using the techniques described herein (or a second 3D point cloud if no point cloud was generated at block 338).

At block 342, processing logic determines a position and orientation of the non-structured light portion of the second image data relative to the 3D surface based on the structured light portion of the second image data (e.g., the second 3D point cloud generated from the structured light portion of the second image data) and the third point cloud. In one embodiment, the second 3D point cloud may be registered and stitched to the third 3D point cloud to generate a combined 3D point cloud. The combined 3D point cloud may then be registered and stitched to the 3D surface. The position and orientation of the structured light portion of the second image data relative to the 3D surface may be the same as the position and orientation of the nonstructured portion of the second image data relative to the 3D surface. Accordingly, once the structured light portion of the second image data is registered to the 3D surface, a position and orientation of the nonstructured light portion of the second image data relative to the 3D surface may be known. In one embodiment, at block 343 processing logic interpolates a position and/or orientation that the intraoral scanner had at the second time when the second image data was captured based on stitching of the third point cloud to the 3D surface. The first image data, second image data and third image data may each have an associated time stamp. Positions and orientations of the intraoral scanner may be determined for the first and third image data with high accuracy. Interpolation may then be performed between the position and orientation of the scanner at the first time and the position and orientation of the scanner at the third time to estimate the position and orientation of the scanner at the second time. This data may be used together with a position and orientation of the scanner at the second time as determined from registering the second point cloud to the third point cloud and/or to the 3D surface to determine a position and orientation of the scanner at the second time. In embodiments, combining information from the interpolation with information from stitching of the second 3D point cloud to the 3D surface and/or third point cloud may improve an accuracy of the determination of the position and orientation of the scanner. The position and orientation of the scanner may indicate a relative position and orientation of the nonstructured light portion of the second image data relative to the 3D surface.

At block 344, processing logic may augment the 3D surface using the nonstructured light portion of the second image data.

FIG. 3E illustrates a flow diagram for a method 345 of separating a structured light portion of image data from an nonstructured light portion of image data, in accordance with embodiments of the present disclosure. Method 345 may be performed, for example, at block 306 of method 300, at block 326 of method 320 and/or at block 338 of method 332 in some embodiments. Method 345 may be performed on image data captured during concurrent projection of structured light and nonstructured light onto an object. Such image data may include a structure light portion and a nonstructured light portion. In embodiments, the image data on which method 345 is performed includes the second image data from any of the preceding methods. The second image data may have been generated during concurrent projection of second structured light and nonstructured light in embodiments.

At block 346 of method 345, processing logic may identify saturated pixels in the second image data. Saturated pixels may be identified based on the intensity values of those pixels. Each pixel may have a maximum intensity value. Once that maximum intensity value is reached, the pixel becomes saturated. For saturated pixels, it may be more difficult to separate out contributions to intensity values of those pixels from the structured light portion and from the nonstructured light portion of the second image data. Additionally, such separated contributions may have decreased accuracy. For example, saturation of a pixel may remove linearity of a response assumed in the equations set forth below. Accordingly, at block 347 processing logic may filter out the saturated pixels from the second image data. In some embodiments, where still light or partial saturation is determined the pixels may not be filtered out. In some embodiments, in the case of stronger saturation or saturated regions, processing logic can use fill in regions, or not use the regions in further processing.

At block 348, processing logic may determine what type of light was used for the nonstructured light. For nonstructured light that has a single wavelength (e.g., that is coherent), it may be easier to separate the nonstructured light portion of the image data from the structured light portion of the image data as compared to nonstructured light that has multiple wavelengths (e.g., such as white light). Accordingly, in one embodiment at block 348 processing logic may determine a light type of the nonstructured light. If the light type is white light, the method may continue to block 349. If the light type is infrared light (or ultraviolet light), the method may proceed to block 356.

At block 356, processing logic determines a contribution of the second structured light to measured intensity values for one or more color channels in the second image data. Processing logic may determine measured intensity values for one or more color channels in the image data. This may include at block 357 determining, for each pixel of the image data, an intensity value of one or more color channels for that pixel. At block 358, for each pixel processing logic determines a contribution of the second structured light to the intensity value and a contribution of the nonstructured light to the intensity value for the one or more color channels of the pixel. In one embodiment, at block 359 processing logic inputs the intensity values into a set of functions that account for a) crosstalk of the second structured light of a first wavelength associated with a first color channel into one or more other color channels and b) a relative response of each color channel to the nonstructured light. The set of functions may output, for each color channel, a contribution to an intensity value of the color channel by the second structured light. In some embodiments, the set of functions is an overconstrained set of functions, which may increase an accuracy of a determined solution.

Different pixels in the images of the second image data may have different amounts of interference between the structured light and the nonstructured light. Such interference can be overcome in embodiments, resulting in separated structured light portions and nonstructured light portions of the each of the images. In order to overcome the interference, pixel level or patch level (e.g., where a patch includes a small group of nearby or adjoining pixels) separation of intensity contributions from the structured light and the nonstructured light may be performed.

An example of performing such separation is provided below for the use case where the structured light is a first wavelength (e.g., blue light or green light) and the nonstructured light is a second wavelength (e.g., infrared light or NIR light). The Near IR wavelength penetrates all of the color filters of a standard Bayer color filter at a similar intensity. Accordingly, the measured infrared light at nearby pixels having different color filters should be comparable. Furthermore, if the structured light is of a color corresponding to a particular color channel (e.g., blue structured light corresponding to the blue color channel or green structured light corresponding to the green color channel), then the structured light will mostly penetrate the color filters of their own color and only a small amount of the structured light will penetrate the other color filters. For example, 100% of blue structured light may be seen by pixels with a blue filter and a small percentage of the blue structured light may be seen by pixels with a red or green filter.

Accordingly, in a region (e.g., pixel) without a feature of the structured light (e.g., without a spot of the structured light pattern) the only contribution to a measured intensity is from the nonstructured light (e.g., the NIRI data). In a region (e.g., a pixel) with a feature (e.g., a region that has picked up a spot of the structured light pattern), both the structured light and the nonstructured light contribute to the measured intensity. The amounts of contributions in such regions (e.g., pixels) at which a feature of the structured light was captured will depend on the amount of the structured light that penetrates each of the color filters and the amount of the nonstructured light that penetrates each of the color filters. These amounts will be different for each color filter and each type of light. However, these values may be determined based on calibration of the scanner and may be used to generate a set of functions in embodiments. Measured intensity values may be input into the set of functions to solve for contributions of each of the structured light and the nonstructured light to each color channel in embodiments.

In one embodiment, the image data may be debayered to determine intensity values for each of the color channels at each pixel. Color image sensors (e.g., complementary metal oxide semiconductor (CMOS)) image sensors usually have four color channels (two greens, one red and one blue). The image sensor has a sensitive layer of pixels which measure the intensity of light impinging on each pixel, and converts the measured intensity into a numerical value. This sensitive layer of pixels is essentially monochrome, and does not measure color information. However, above the sensitive layer of pixels is a grid of color filters, where each pixel has its own color filter. These filters selectively allow light of a particular wavelength (e.g., red, green or blue light, and in some instances IR light). The grid of color filters may be referred to as a Bayer Matrix or a Bayer Filter. Different types of Bayer Filters may have different arrangements of individual color filters.

Debayering, also known as demosaicing, is the process of reconstructing a full-color image from the incomplete color data captured by a camera's image sensor. As indicated above, the Bayer filter is a mosaic of color filters, generally arranged in a repeating pattern (e.g., a repeating 2×2 pattern). Often 50% of the pixels include a green filter (e.g., capture green light), 25% of the pixels include a blue filter (e.g., capture blue light), and 25% of the pixels include a red filter (e.g., capture red light). However, other arrangements may be used, such as where some pixels include an IR filter. From the raw image data, a single pixel contains only one color value (e.g., R, G, or B). To display or process the image, debayering is performed to estimate the missing two color components for each pixel and reconstruct a full-color image. The debayering process uses interpolation algorithms to estimate the missing color components for each pixel based on the values of neighboring pixels. Multiple different debayering methods may be used, including nearest neighbor interpolation, bilinear interpolation, gradient-based interpolation, adaptive interpolation, and/or frequency domain and/or machine learning methods (e.g., using a neural network to perform debayering).

When the image data is debayered, R,G,B pixel values for each pixel position are determined. For example, for a pixel exposed to a blue pattern feature the following may be computed (in 8 bit Gray level units):

$$Rpix = Niri energy ( 100 gl ) + Blue spot energy ( 4 gl ) = 104$$

$$Gpix = Niri energy ( 90 gl ) + Blue spot energy ( 10 gl ) = 100$$

$$Bpix = Niri energy ( 85 gl ) + Blue spot energy ( 80 gl ) = 165$$

The pixels may have a known response to the infrared light. For example, 100% of the infrared light may penetrate the red filter, 90% of the infrared light may penetrate the green filter, and 85% of the infrared light may penetrate the blue filter. By knowing the relative response of the color filters to NIRI, we can write:

$$R = x + 0.05 y$$

$$G = 0. 9 x + 0.125 y$$

$$B = 0. 85 x + y$$

Where R is the light intensity measured for the red color channel, G is the light intensity measured for the green color channel, B is the light intensity measured for the blue color channel, x is the intensity of the infrared light reaching a pixel and y is the intensity of blue structured light reaching a pixel.

The above equations solving for x and y are overconstrained, because there are two variables and three equations. This can increase an accuracy of a determined solution. Processing logic can solve the over determined equations to estimate and separate the NIRI value (contribution of nonstructured light) from the Blue value (contribution of structured light).

For example, a matrix A may be constructed as follows based on the above set of functions:

$$A = [ [ 1. , 0.05 ] , [ 0.9 , 0.125 ] , [ 0.85 , 1. ] ]$$

Additionally, an example vector RGB may be generated that includes intensity values of each of the color channels for a pixel, as follows:

$$RGB = [ 104 , 100 , 165 ]$$

The vector may be multiplied by the matrix as follows to solve for the structured light intensity and the nonstructured light intensity for the pixel:

$$( inv ( A . T \times A ) \times A . T ) \times RGB$$

Using the above example values, the matrix multiplication would yield:

$$[ [ 0.62288937 , 0.50845156 , - 0.09470091 ] , [ - 0.57033811 , - 0.38286773 , 1.07637537 ] ] ,$$

which would give [100, 80].

Accordingly, in the above example the nonstructured light contribution to the pixel intensity is 100 and the structured light contribution to the pixel intensity is 80. This separation technique may be performed across the pixels of the second image data to separate the second image data into two different sets of image data. Accordingly, each image of the second image data may be separated into a structured light image (e.g., structured light portion) and a nonstructured light image (e.g., nonstructured light portion).

The above technique continues to work well even when noise is added. Due to noise and debayer interpolation errors, the estimation may have a small level of inaccuracy. However, other low pass filters may be applied to reduce this error in embodiments.

If white light illumination is used rather than nonstructured light illumination using a single wavelength, the ability to separate contributions to measured intensities in the pixel level reduces, as the object color has additional spectral components. Such additional spectral components may be similar to spectral components of the structured light in embodiments.

Accordingly, if at block 348 processing logic determines that white light is being projected, the method proceeds to block 349 to perform additional processing before the operations of block 356 are performed to improve an ability to separate out the structured light contribution to measured intensity values from the nonstructured light contribution to the measured intensity values.

At block 349, processing logic estimates a color of the object being imaged. Different colors of the object may be estimated for different regions. Accordingly, a first object color may be estimated for a first set of pixels and a second object color may be estimated for a second set of pixels in embodiments. An estimated color of the object will have unknown contributions to the different color channels (e.g., RGB components). However, processing logic can estimate these responses from a larger region of the object, or iteratively start with assumptions on the color of the region, and run the pixel separation in two or three iterations.

In one embodiment, at block 350 processing logic determines an object class of the object. This may include at block 351 processing the second image data using a trained artificial intelligence (AI) model (e.g., a trained ML model) that may output object class information. For example, the AI model may perform image segmentation, and may output segmentation information identifying gingiva, teeth, etc. in the second image data. Each type of oral object may have a known color range. For example, teeth are known to be whitish and/or yellowish, gingiva is known to be pinkish or reddish, and so on. Such information may be used to facilitate color estimation of the object around different pixels in embodiments.

At block 352, processing logic may identify pattern features of the structured light portion of the image data. In some embodiments, the pattern features are identified using standard image processing techniques, such as thresholding. Areas in which the structured light pattern features appear may tend to have greater intensity than areas where the structured light pattern features do not appear. Accordingly, such intensity differences may be used to identify where in the second image data structured light pattern features appear. In some embodiments, the second image data is processed using a trained AI model that outputs information on locations of pattern features of the structured light pattern captured in the second image data.

At block 353, processing logic may estimate a color of the object based on the object class. In embodiments, the color of the object is estimated around the identified locations of the image features. At block 354, processing logic may estimate object color at each pixel associated with an image feature. The object color for such a pixel may be determined based on the object color of pixels surrounding the pixels associated with captured features of a structured light pattern and/or based on the determined object class.

At block 355, processing logic may determine how to separate the structured light portion of the second image data from the nonstructured light portion of the second image data based on the estimated color of the object.

At block 356, the techniques described above may be performed for white nonstructured light in a similar way that they are described for infrared light. However, the contribution to the different color channels may be determined based on the estimated color of the object rather than based on the wavelength of the nonstructured light. For any given color, processing logic may include a table of contributions of light at that color to measured intensities of each of the color channels. The table may be used to populate the values used for the above equations in embodiments.

FIG. 3F illustrates a flow diagram for a method 360 of selectively illuminating a region of interest using nonstructured light (e.g., a region of a tooth likely to have a caries using infrared light), in accordance with embodiments of the present disclosure. As discussed above, structured light and nonstructured light may be projected concurrently onto an oral object during intraoral scanning. In embodiments, processing logic may determine which structured light projectors and which nonstructured light projectors to use at a given time to generate image data that has the most useful information possible. For example, it may be useful to project infrared light onto areas that have an increased likelihood of developing caries (e.g., an interproximal region of teeth) and to avoid projecting structured light onto these regions. Infrared light may be used to detect caries. By projecting infrared light onto areas likely to develop caries, information about caries in such areas can be determined. Shining structured light onto such areas during infrared imaging may introduce noise and reduce an ability to accurately identify caries. Accordingly, it may be beneficial to project structured light that is concurrently projected with nonstructured infrared light onto other areas. This enables the structured light to be used as described above without reducing an accuracy of caries detection in embodiments.

At block 362, processing logic determines a region of interest. This may include, for example, determining a region of a tooth that has an increased risk of caries (e.g., an interproximal region of a tooth). In one embodiment, the region of interest is determined by inputting prior image data into a trained ML model that outputs an indication of a region of interest. The output of the ML model may be, for example, segmentation information and/or a bounding box around the region of interest.

In one embodiment, at block 364 processing logic projects white light onto an object being scanned. At block 366, processing logic may capture image data of the white light projected onto the object. At block 368, processing logic processes the image data using an AI model (e.g., an ML model) that outputs an indication of the region of interest.

At block 369, processing logic determines a light projection scheme to use that involves concurrent projection of structured light and nonstructured light. For the light projection scheme, the nonstructured light is projected onto the region of interest and the structured light (e.g., second structured light of the prior methods) is not projected onto the region of interest.

Method 360 is discussed with reference to determining how and where to project structured light and nonstructured infrared light for the purpose of caries detection. However, it should be understood that the above technique described with reference to determining how/where to project structured light and nonstructured infrared light for caries detection also applies to concurrent projection of structured light and nonstructured light for other purposes. The nonstructured light in such instances may be infrared light or other light (e.g., white light, ultraviolet light, etc.). For example, processing logic may determine an area of interest for which nonstructured light illumination is desired and structured light illumination is not desired. Processing logic may then determine which structured light projectors and/or which nonstructured light projectors to concurrently activate and/or may determine a structured light pattern to use such that the nonstructured light is projected onto the region of interest and the structured light is not projected onto the region of interest.

FIG. 3G illustrates a flow diagram for a method 370 of adjusting the intensity of structured light that is concurrently projected with nonstructured light, in accordance with embodiments of the present disclosure. A regular structured light pulse (e.g., structured light projection that is performed on its own) is optimized for best feature (e.g., spot) capture with as little as possible saturated points or spots. But when concurrently projecting structured light and nonstructured light, the optimization is different. Saturation reduces an ability to reconstruct the underling nonstructured light information that is captured. The optimization of the structured light can be performed such that fewer features of the structured light are captured (e.g., fewer spots are identified), in return for better nonstructured light (e.g., NIRI and/or white light) reconstruction.

Increasing an intensity of structured light may improve a detectability of image features of structured light that are captured in image data. However, such increases in the intensity of structured light may introduce increased interference with color images, infrared images, etc. captured using nonstructured light. Accordingly, the intensity of the structured light may be adjusted dynamically based on imaging conditions to optimize detection of features of structured light projected onto an object and image quality of the object from the nonstructured light.

At block 372, processing logic detects a saturation level of captured image data (e.g., a number of saturated pixels and/or a percentage of pixels that are saturated) and/or a number of detected pattern features of the projected structured light that was projected concurrently with nonstructured light. At block 374, processing logic determines an intensity of the structured light (e.g., second structured light) based on at least one of the saturation level or the number of detected pattern features. If the saturation level is above a saturation threshold, then the intensity of the structured light may be reduced. If the number of detected pattern features is below a threshold number, then the intensity of the structured light may be increased. At block 376, processing logic adjusts the intensity of the structured light (e.g., the second structured light) that is concurrently projected with nonstructured light based on the determination.

Any one or more of methods 300-370 may be combined in embodiments.

FIG. 3H illustrates a flow diagram for a method 380 of separating first structured light from second structured light in image data, in accordance with embodiments of the present disclosure. The method 380 may be performed by processing logic that comprises hardware (e.g., circuitry, dedicated logic, programmable logic, microcode, etc.), software (such as instructions run on a processing device), or a combination thereof.

At block 382 of method 380, processing logic causes one or more first structured light projectors of an intraoral scanner to project first structured light (e.g., a first light pattern comprising first pattern features having a first wavelength) onto an object (e.g., an intraoral object such as a tooth, gingiva, etc.) and one or more second structured light projectors to concurrently project second structured light (e.g., a second light pattern comprising second pattern features having a second wavelength) onto the object. At block 384, processing logic causes cameras of the intraoral scanner to capture first image data of the first structured light and the second structured light projected onto the object.

At block 386, processing logic may separate a first structured light portion of the first image data from second structured light portion of the first image data. The same separation process as described above with reference to the above described methods may be performed for the separation in some embodiments. However, rather than separating a structured light portion from a nonstructured light portion the process may be performed to separate a first structured light portion from a second structured light portion.

At block 388, processing logic may generate a first 3D point cloud based on the first structured light portion of the first image data and generated a second 3D point cloud based on the second structured light portion of the first image data. These two 3D point clouds may then be combined into a single 3D point cloud in embodiments, which may be registered and stitched with other 3D point clouds generated from image data captured at different times to generate a 3D surface or 3D model.

Use of AI models (e.g., ML models) is described herein for multiple purposes, such as for identifying features of a structured light pattern, identifying a region of interest, separating a structured light portion of image data from an nonstructured light portion of image data, and so on. Any such AI model may be trained according to a training workflow and used according to a model application workflow in embodiments. In embodiments, the model training workflow may be performed at a server which may or may not include an intraoral scan application, and the trained models are provided to an intraoral scan application (e.g., on computing device 405 of FIG. 4), which may perform the model application workflow (e.g., which may include execution of any of methods 300-370). The model training workflow and/or the model application workflow may be performed by processing logic executed by a processor of a computing device and/or by a processor of an intraoral scanner. One or more of these workflows, or portions thereof, may be implemented, for example, by one or more machine learning modules implemented in an intraoral scanning module 408 or other software and/or firmware executing on a processing device of computing device 405 shown in FIG. 4.

The model training workflow is to train one or more machine learning models (e.g., deep learning models) to perform one or more classifying, segmenting, detection, recognition, separation, etc. tasks for intraoral scan data (e.g., 3D scans, height maps, 2D color images, NIRI images, combined images that include a structured light portion and an nonstructured light portion, etc.). The model application workflow is to apply the one or more trained machine learning models to perform the classifying, segmenting, detection, recognition, separation, etc. tasks for intraoral scan data. One or more of the machine learning models may receive and process image data.

Many different machine learning outputs are described herein. Particular numbers and arrangements of machine learning models are described and shown. However, it should be understood that the number and type of machine learning models that are used and the arrangement of such machine learning models can be modified to achieve the same or similar end results. Accordingly, the arrangements of machine learning models that are described and shown are merely examples and should not be construed as limiting.

In embodiments, one or more machine learning models are trained to perform one or more of the below tasks. Each task may be performed by a separate machine learning model. Alternatively, a single machine learning model may perform each of the tasks or a subset of the tasks. Additionally, or alternatively, different machine learning models may be trained to perform different combinations of the tasks. In an example, one or a few machine learning models may be trained, where the trained ML model is a single shared neural network that has multiple shared layers and multiple higher level distinct output layers, where each of the output layers outputs a different prediction, classification, identification, etc. The tasks that the one or more trained machine learning models may be trained to perform are as follows:
I) Structured light portion and nonstructured light portion separation—this can include determining, for each pixel of input image data, and for each color channel, a contribution of structured light to a measured intensity and a contribution of nonstructured light to the measured intensity. The ML model may output two maps in one embodiment. A first map may include, for each pixel and each color channel, intensities attributable to the nonstructured light captured in the image. A second map may include, for each pixel and each color channel, intensities attributable to the structured light captured in the image.
II) Region of interest identification—this can include performing instance segmentation or semantic segmentation on input image data to provide segmentation information that may identify, for each pixel of input image data, a classification of one or more regions associated with the pixel. This can additionally or alternatively include outputting a location and size of a bounding box around an identified region of interest.
III) Structured light pattern identification—this can include processing input image data and outputting coordinates of each identified feature of a projected structured light pattern captured in image data.
IV) Object detection—this can include performing instance segmentation or semantic segmentation on input image data to provide segmentation information that may identify, for each pixel of input image data, an object or object class associated with the pixel. This can additionally or alternatively include outputting a location and size of a bounding box around an identified object.

One type of AI model that may be used to perform some or all of the above asks is an artificial neural network, such as a deep neural network. Artificial neural networks generally include a feature representation component with a classifier or regression layers that map features to a desired output space. A convolutional neural network (CNN), for example, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g. classification outputs). Deep learning is a class of machine learning algorithms that use a cascade of multiple layers of nonlinear processing units for feature extraction and transformation. Each successive layer uses the output from the previous layer as input. Deep neural networks may learn in a supervised (e.g., classification) and/or unsupervised (e.g., pattern analysis) manner. Deep neural networks include a hierarchy of layers, where the different layers learn different levels of representations that correspond to different levels of abstraction. In deep learning, each level learns to transform its input data into a slightly more abstract and composite representation. In an image recognition application, for example, the raw input may be a matrix of pixels; the first representational layer may abstract the pixels and encode edges; the second layer may compose and encode arrangements of edges; the third layer may encode higher level shapes (e.g., teeth, lips, gums, etc.); and the fourth layer may recognize a scanning role. Notably, a deep learning process can learn which features to optimally place in which level on its own. The “deep” in “deep learning” refers to the number of layers through which the data is transformed. More precisely, deep learning systems have a substantial credit assignment path (CAP) depth. The CAP is the chain of transformations from input to output. CAPs describe potentially causal connections between input and output. For a feedforward neural network, the depth of the CAPs may be that of the network and may be the number of hidden layers plus one. For recurrent neural networks, in which a signal may propagate through a layer more than once, the CAP depth is potentially unlimited.

Training of a neural network may be achieved in a supervised learning manner, which involves feeding a training dataset consisting of labeled inputs through the network, observing its outputs, defining an error (by measuring the difference between the outputs and the label values), and using techniques such as deep gradient descent and backpropagation to tune the weights of the network across all its layers and nodes such that the error is minimized. In many applications, repeating this process across the many labeled inputs in the training dataset yields a network that can produce correct output when presented with inputs that are different than the ones present in the training dataset. In high-dimensional settings, such as large images, this generalization is achieved when a sufficiently large and diverse training dataset is made available.

For the model training workflow, a training dataset containing hundreds, thousands, tens of thousands, hundreds of thousands or more intraoral scans, images, etc. should be used to form a training dataset. In embodiments, up to millions of cases of patient dentition that may have underwent a prosthodontic procedure and/or an orthodontic procedure may be available for forming a training dataset, where each case may include various labels of one or more types of useful information. Each case may include, for example, image data of one or more dental sites, and data showing a desired output associated with the image data (e.g., pixel-level segmentation of the data into various dental classes (e.g., tooth, restorative object, gingiva, moving tissue, upper palate, etc.), data showing one or more assigned classifications for the data, and so on. This data may be processed to generate one or multiple training datasets for training of one or more machine learning models.

To effectuate training, processing logic inputs the training dataset(s) into one or more untrained machine learning models. Prior to inputting a first input into a machine learning model, the machine learning model may be initialized. Processing logic trains the untrained machine learning model(s) based on the training dataset(s) to generate one or more trained machine learning models that perform various operations as set forth above.

Training may be performed by inputting one or more of the images, scans, etc. into the machine learning model one at a time. Each input may include data from an image, intraoral scan, etc. in a training data item from the training dataset. The machine learning model processes the input to generate an output. An artificial neural network includes an input layer that consists of values in a data point (e.g., intensity values and/or height values of pixels in a height map). The next layer is called a hidden layer, and nodes at the hidden layer each receive one or more of the input values. Each node contains parameters (e.g., weights) to apply to the input values. Each node therefore essentially inputs the input values into a multivariate function (e.g., a non-linear mathematical transformation) to produce an output value. A next layer may be another hidden layer or an output layer. In either case, the nodes at the next layer receive the output values from the nodes at the previous layer, and each node applies weights to those values and then generates its own output value. This may be performed at each layer. A final layer is the output layer, where there is one node for each class, prediction and/or output that the machine learning model can produce. For example, for an artificial neural network being trained to perform dental site classification, there may be a first class (excess material), a second class (teeth), a third class (gums), a fourth class (restorative objects) and/or one or more additional dental classes. Moreover, the class, prediction, etc. may be determined for each pixel in the image/scan/surface, may be determined for an entire image/scan/surface, or may be determined for each region or group of pixels of the image/scan/surface. For pixel level segmentation, for each pixel in the image/scan/surface, the final layer applies a probability that the pixel of the image/scan/surface belongs to the first class, a probability that the pixel belongs to the second class, a probability that the pixel belongs to the third class, and/or one or more additional probabilities that the pixel belongs to other classes.

Accordingly, the output may include one or more prediction and/or one or more a probability map. For example, an output probability map may comprise, for each pixel in an input image/scan/surface, a first probability that the pixel belongs to a first dental class, a second probability that the pixel belongs to a second dental class, and so on. For example, the probability map may include probabilities of pixels belonging to dental classes representing a tooth, gingiva, or a restorative object. In further embodiments, different dental classes may represent different types of restorative objects.

Processing logic may then compare the generated probability map and/or other output to the known probability map and/or label that was included in the training data item. Processing logic determines an error (i.e., a classification error) based on the differences between the output probability map and/or label(s) and the provided probability map and/or label(s). Processing logic adjusts weights of one or more nodes in the machine learning model based on the error. An error term or delta may be determined for each node in the artificial neural network. Based on this error, the artificial neural network adjusts one or more of its parameters for one or more of its nodes (the weights for one or more inputs of a node). Parameters may be updated in a back propagation manner, such that nodes at a highest layer are updated first, followed by nodes at a next layer, and so on. An artificial neural network contains multiple layers of “neurons”, where each layer receives as input values from neurons at a previous layer. The parameters for each neuron include weights associated with the values that are received from each of the neurons at a previous layer. Accordingly, adjusting the parameters may include adjusting the weights assigned to each of the inputs for one or more neurons at one or more layers in the artificial neural network.

Once the model parameters have been optimized, model validation may be performed to determine whether the model has improved and to determine a current accuracy of the deep learning model. After one or more rounds of training, processing logic may determine whether a stopping criterion has been met. A stopping criterion may be a target level of accuracy, a target number of processed images from the training dataset, a target amount of change to parameters over one or more previous data points, a combination thereof and/or other criteria. In one embodiment, the stopping criteria is met when at least a minimum number of data points have been processed and at least a threshold accuracy is achieved. The threshold accuracy may be, for example, 70%, 80% or 90% accuracy. In one embodiment, the stopping criteria is met if accuracy of the machine learning model has stopped improving. If the stopping criterion has not been met, further training is performed. If the stopping criterion has been met, training may be complete. Once the machine learning model is trained, a reserved portion of the training dataset may be used to test the model.

FIG. 4 illustrates one embodiment of a system 400 for performing intraoral scanning and/or generating a virtual 3D model of a dental arch. In one embodiment, system 400 carries out one or more operations of the above described methods. System 400 includes a computing device 405 that may be coupled to an intraoral scanner 450 (also referred to simply as a scanner 450) and/or a data store 410 via a wired or wireless connection.

Computing device 405 may include a processing device, memory, secondary storage, one or more input devices (e.g., such as a keyboard, mouse, tablet, and so on), one or more output devices (e.g., a display, a printer, etc.), and/or other hardware components. Computing device 405 may be connected to a data store 410 either directly or via a network. The network may be a local area network (LAN), a public wide area network (WAN) (e.g., the Internet), a private WAN (e.g., an intranet), or a combination thereof. The computing device and the memory device may be integrated into the scanner in some embodiments to improve performance and mobility.

Data store 410 may be an internal data store, or an external data store that is connected to computing device 405 directly or via a network. Examples of network data stores include a storage area network (SAN), a network attached storage (NAS), and a storage service provided by a cloud computing service provider. Data store 410 may include a file system, a database, or other data storage arrangement.

In some embodiments, a scanner 450 for obtaining three-dimensional (3D) data of a dental site in a patient's oral cavity is also operatively connected to the computing device 405. Scanner 450 may include a probe (e.g., a hand held probe) for optically capturing three dimensional structures.

In some embodiments, the scanner 450 includes an elongate wand including a probe at a distal end of the wand; a rigid structure disposed within a distal end of the probe; one or more structured light projectors coupled to the rigid structure (and optionally one or more non-structured light projectors coupled to the rigid structure, such as non-coherent light projectors and/or near-infrared light projectors); and one or more cameras coupled to the rigid structure. In some applications, each light projector may have an AFOI of 45-120 degrees. Optionally, the one or more light projectors may utilize a laser diode light source. Further, the structure light projector(s) may include a beam shaping optical element. Further still, the structured light projector(s) may include a pattern generating optical element.

The pattern generating optical element may be configured to generate a light pattern such as a distribution of discrete unconnected spots of light. The light pattern may be generated at all planes located between specific distances (e.g., 0-30 mm, 0-20 mm etc.) from the pattern generating optical element when the light source (e.g., laser diode) is activated to transmit light through the pattern generating optical element. In some applications, the pattern generating optical element utilizes diffraction and/or refraction to generate the distribution. Optionally, the pattern generating optical element has a light throughput efficiency of at least 90%.

For some applications, the light projectors and the cameras are positioned such that each light projector faces an object outside of the wand placed in its field of illumination. Optionally, each camera may face an object outside of the wand placed in its field of view. Additionally, or alternatively, one or more light projectors and/or cameras may face a mirror that reflects light to/from an object being scanned. Further, in some applications, at least 20% of the pattern features are in the field of view of at least one of the cameras.

The scanner 450 may be used to perform intraoral scanning of a patient's oral cavity. A result of the intraoral scanning may be a sequence of image data 435A that is generated using only structured light (also referred to as intraoral scans), image data 435B generated using a combination of structured light and nonstructured light that are concurrently projected onto an imaged surface, and/or image data 435C generated using only nonstructured light. The image data 435A-C may each include one or multiple sets of images, where for each set of images that images of the set are simultaneously generated. An operator may start recording the sequence of image data 435A-C with the scanner 450 at a first position in the oral cavity, move the scanner 450 within the oral cavity to a second position while the sequence of images is being taken, and then stop recording. In some embodiments, recording may start automatically as the scanner identifies that it has been positioned in the oral cavity of a patient. In either case, the scanner 450 may transmit the image data 435A-C to the computing device 405. Note that in some embodiments the computing device may be integrated into the scanner 450. Computing device 405 may store the scan data 435 in data store 410. Alternatively, scanner 450 may be connected to another system that stores the scan data in data store 410. In such an embodiment, scanner 450 may not be connected to computing device 405.

Scanner 450 may drive each one of one or more light projectors to project light (e.g., structured light and/or nonstructured light) on an intraoral three-dimensional surface. Scanner 450 may further drive each one of one or more cameras to capture an image, the image including one or more image features corresponding to pattern features projected by one of the light projectors of the scanner 450. Each one of the one or more cameras may include a camera sensor including an array of pixels. The images captured together at a particular time may together form image data comprising a set of images. The imager data 435A-C may be transmitted to computing device 405 and/or stored in data store 410.

Computing device 405 may include an intraoral scanning module 408 for facilitating intraoral scanning and generating 3D surfaces and/or 3D models of dental arches from intraoral scans. Intraoral scanning module 408 may include an surface detection module 415 and a model generation module 425 in some embodiments. Surface detection module 415 may analyze received image data 435A-C to identify objects in the intraoral scans of the image data 435. Surface detection module 415 may execute a correspondence algorithm on intraoral scans (image data) to determine the depths of features captured in the image data (e.g., spots or points of the structured light pattern captured in the image data). The surface detection module 415 may access stored calibration data 430 indicating (a) a camera ray of an image feature corresponding to each pixel on the camera sensor of each one of the one or more cameras, and (b) a projector ray corresponding to each of the projected pattern features from each one of the one or more projectors, where each projector ray corresponds to a respective path of pixels on at least one of the camera sensors. Using the calibration data 430 and the correspondence algorithm, surface detection module 415 may, (1) for each projector ray i, identify for each detected image feature j on a camera sensor path corresponding to ray i, how many other cameras, on their respective camera sensor paths corresponding to ray i, detected respective image features k corresponding to respective camera rays that intersect ray i and the camera ray corresponding to detected image feature j. Ray i is identified as the specific projector ray that produced a detected image feature j for which the highest number of other cameras detected respective image features k. Surface detection module 415 may further (2) compute a respective three-dimensional position on an intraoral three-dimensional surface at the intersection of projector ray i and the respective camera rays corresponding to the detected image feature j and the respective detected image features k. For some applications, running the correspondence algorithm further includes, following operation (1), removing from consideration projector ray i, and the respective camera rays corresponding to the detected image feature j and the respective detected image features k, and running the correspondence algorithm again for a next projector ray i.

In embodiments, for image data 435B that includes both a structured light portion and an nonstructured light portion, surface detection module 415 performs one or more operations to separate the structured light portion from the nonstructured light portion. The correspondence algorithm may then be applied to captured image features of the structured light portion of the image data 435B.

Model generation module 425 may perform surface registration between 3D point clouds generated from image data 435A, 435B. Model generation module 425 may then generate a virtual 3D surface or model of a dental arch from the registered 3D point clouds, as discussed above. Model generation module 425 may further augment the 3D model/surface based on the separated nonstructured light portion of image data 435B and/or based on image data 435C in embodiments. This may include adding one or more textures to the 3D surface/model based on the nonstructured light portion of image data 435B, for example.

In some embodiments, intraoral scanning module 408 includes a user interface module 409 that provides a user interface that may display the generated virtual 3D surface/model.

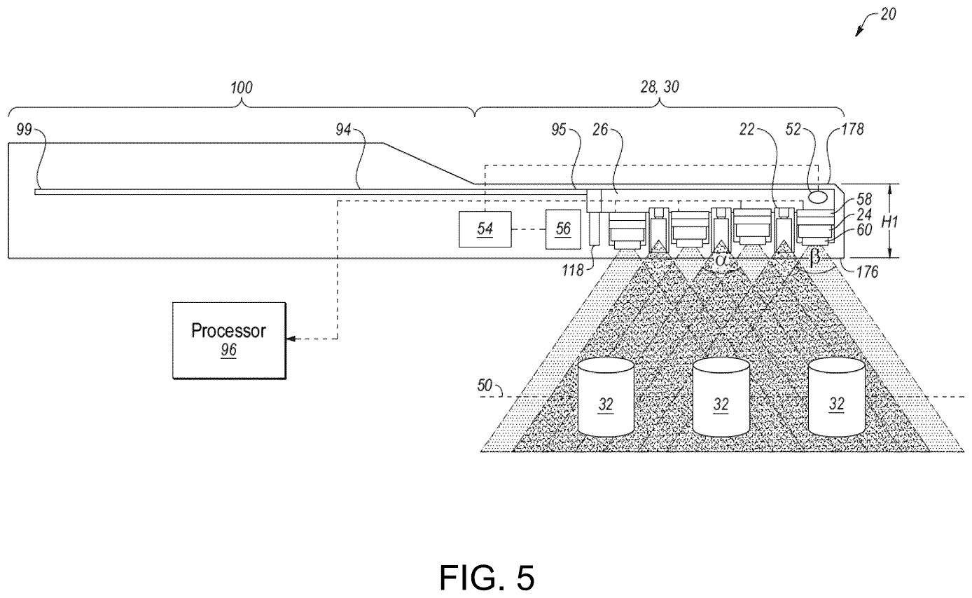

Reference is now made to FIG. 5, which is a schematic illustration of an elongate wand 20 for intraoral scanning, in accordance with some applications of the present disclosure. A plurality of light projectors 22 (e.g., including structured light projectors and/or nonstructured light projectors) and a plurality of cameras 24 are coupled to a rigid structure 26 disposed within a probe 28 at a distal end 30 of the wand. In some applications, during an intraoral scan, probe 28 enters the oral cavity of a subject.

For some applications, light projectors 22 are positioned within probe 28 such that one or more light projector 22 faces a 3D surface 32A and/or a 3D surface 32B outside of wand 20 that is placed in its field of illumination, as opposed to positioning the light projectors in a proximal end of the wand and illuminating the 3D surface by reflection of light off a mirror and subsequently onto the 3D surface. Similarly, for some applications, cameras 24 are positioned within probe 28 such that each camera 24 faces a 3D surface 32A, 32B outside of wand 20 that is placed in its field of view, as opposed to positioning the cameras in a proximal end of the wand and viewing the 3D surface by reflection of light off a mirror and into the camera. This positioning of the projectors and the cameras within probe 28 enables the scanner to have an overall large field of view while maintaining a low profile probe.

In some applications, a height H1 of probe 28 is less than 15 mm, height H1 of probe 28 being measured from a lower surface 176 (sensing surface), through which reflected light from 3D surface 32A, 32B being scanned enters probe 28, to an upper surface 178 opposite lower surface 176. In some applications, the height H1 is between 10-15 mm.

In some applications, cameras 24 each have a large AFOV β (beta) of at least 45 degrees, e.g., at least 70 degrees, e.g., at least 80 degrees, e.g., 85 degrees. In some applications, the field of view may be less than 120 degrees, e.g., less than 100 degrees, e.g., less than 90 degrees. In experiments performed by the inventors, AFOV β (beta) for each camera being between 80 and 90 degrees was found to be particularly useful because it provided a good balance among pixel size, field of view and camera overlap, optical quality, and cost. Cameras 24 may include a camera sensor 58 and objective optics 60 including one or more lenses. To enable close focus imaging cameras 24 may focus at an object focal plane 50 that is located between 1 mm and 30 mm, e.g., between 4 mm and 24 mm, e.g., between 5 mm and 11 mm, e.g., 9 mm-10 mm, from the lens that is farthest from the camera sensor. Cameras 24 may also detect 3D surfaces located at greater distances from the camera sensor, such as 3D surfaces at 40 mm, 50 mm, 60 mm, 70 mm, 80 mm, 90 mm, and so on from the camera sensor.

As described hereinabove, a large field of view achieved by combining the respective fields of view of all the cameras may improve accuracy due to reduced amount of image stitching errors, especially in edentulous regions, where the gum surface is smooth and there may be fewer clear high resolution 3-D features. Having a larger field of view enables large smooth features, such as the overall curve of the tooth, to appear in each image frame, which improves the accuracy of stitching respective surfaces obtained from multiple such image frames.

Similarly, light projectors 22 may each have a large AFOI a (alpha) of at least 45 degrees, e.g., at least 70 degrees. In some applications, AFOI a (alpha) may be less than 120 degrees, e.g., than 100 degrees.

For some applications, in order to improve image capture, each camera 24 has a plurality of discrete preset focus positions, in each focus position the camera focusing at a respective object focal plane 50. Each of cameras 24 may include an autofocus actuator that selects a focus position from the discrete preset focus positions in order to improve a given image capture. Additionally or alternatively, each camera 24 includes an optical aperture phase mask that extends a depth of focus of the camera, such that images formed by each camera are maintained focused over all 3D surface distances located between 1 mm and 30 mm, e.g., between 4 mm and 24 mm, e.g., between 5 mm and 11 mm, e.g., 9 mm-10 mm, from the lens that is farthest from the camera sensor. In further embodiments, images formed by one or more cameras may additionally be maintained focused over greater 3D surface distances, such as distances up to 40 mm, up to 50 mm, up to 60 mm, up to 70 mm, up to 80 mm, or up to 90 mm.

In some applications, light projectors 22 and cameras 24 are coupled to rigid structure 26 in a closely packed and/or alternating fashion, such that (a) a substantial part of each camera's field of view overlaps the field of view of neighboring cameras, and (b) a substantial part of each camera's field of view overlaps the field of illumination of neighboring projectors. Optionally, at least 20%, e.g., at least 50%, e.g., at least 75% of the projected pattern of light are in the field of view of at least one of the cameras at an object focal plane 50 that is located at least 4 mm from the lens that is farthest from the camera sensor. Due to different possible configurations of the projectors and cameras, some of the projected pattern may never be seen in the field of view of any of the cameras, and some of the projected pattern may be blocked from view by 3D surface 32A, 32B as the scanner is moved around during a scan.

Rigid structure 26 may be a non-flexible structure to which light projectors 22 and cameras 24 are coupled so as to provide structural stability to the optics within probe 28. Coupling all the projectors and all the cameras to a common rigid structure helps maintain geometric integrity of the optics of each light projector 22 and each camera 24 under varying ambient conditions, e.g., under mechanical stress as may be induced by the subject's mouth. Additionally, rigid structure 26 helps maintain stable structural integrity and positioning of light projectors 22 and cameras 24 with respect to each other. As further described hereinbelow, controlling the temperature of rigid structure 26 may help enable maintaining geometrical integrity of the optics through a large range of ambient temperatures as probe 28 enters and exits a subject's oral cavity or as the subject breathes during a scan.

As shown, 3D surface 32A and 3D surface 32B are in a FOV of the probe 28, with 3D surface 32A being relatively close to the probe 28 and 3D surface 32B being relatively far from the probe 28.

Whether a pair of cameras or a pair of a camera and a light projector are used, the accuracy of the triangulation used to determine the depth of 3D surfaces may be roughly estimated by the following equation:

$${z}_{err} = \frac{{p}_{err} \cdot {z}^{2}}{f \cdot b}$$

Where zₑᵣᵣ is the error in the depth, pₑᵣᵣ is the basic image processing error (generally a sub-pixel error), z is the depth, f is the focal length of the lens, and b is the base line (the distance between two cameras when using stereo imaging or the distance between the camera and the light projector when using structured light). In embodiments, the probe of the intraoral scanner is configured such that the maximum baseline between two cameras or between a camera and a light projector is large and provides a high level of accuracy for triangulation.

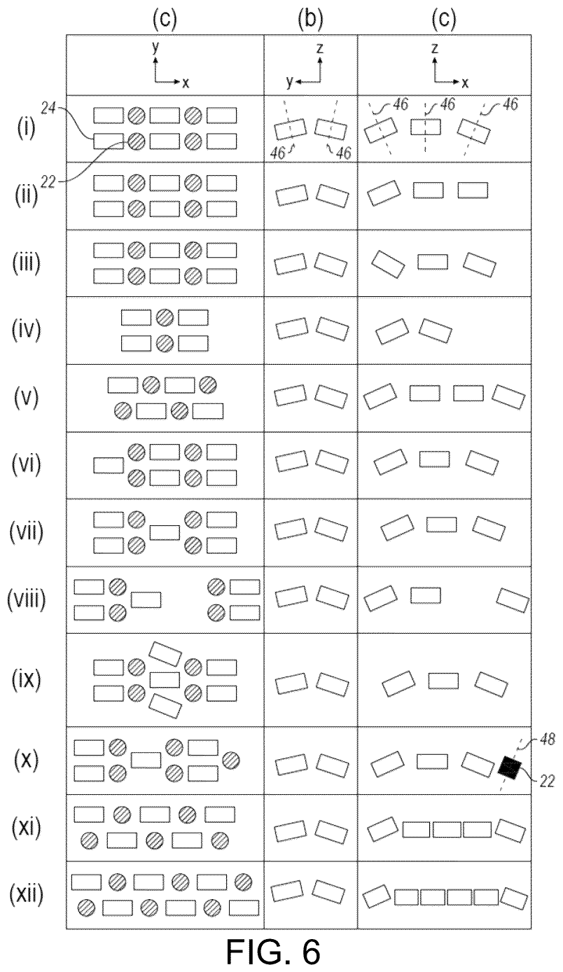

Reference is now made to FIG. 6, which is a chart depicting a plurality of different configurations for the position of light projectors 22 and cameras 24 in probe 28, in accordance with some applications of the present disclosure. Light projectors 22 are represented in FIG. 6 by circles and cameras 24 are represented in FIG. 6 by rectangles. It is noted that rectangles are used to represent the cameras, since typically, each camera sensor 58 and the AFOV β (beta) of each camera 24 have aspect ratios of 1:2. Column (a) of FIG. 6 shows a bird's eye view of the various configurations of light projectors 22 and cameras 24. The x-axis as labeled in the first row of column (a) corresponds to a central longitudinal axis of probe 28. Column (b) shows a side view of cameras 24 from the various configurations as viewed from a line of sight that is coaxial with the central longitudinal axis of probe 28. Column (b) of FIG. 6 shows cameras 24 positioned so as to have optical axes 46 at an angle of 90 degrees or less, e.g., 35 degrees or less, with respect to each other. Column (c) shows a side view of cameras 24 of the various configurations as viewed from a line of sight that is perpendicular to the central longitudinal axis of probe 28.

In one embodiment, the distal-most (toward the positive x-direction in FIG. 6) and proximal-most (toward the negative x-direction in FIG. 6) cameras 24 are positioned such that their optical axes 46 are slightly turned inwards, e.g., at an angle of 90 degrees or less, e.g., 35 degrees or less, with respect to the next closest camera 24. The camera(s) 24 that are more centrally positioned, i.e., not the distal-most camera 24 nor proximal-most camera 24, are positioned so as to face directly out of the probe, their optical axes 46 being substantially perpendicular to the central longitudinal axis of probe 28. It is noted that in row (xi) a projector 22 is positioned in the distal-most position of probe 28, and as such the optical axis 48 of that projector 22 points inwards, allowing a larger number of spots 33 projected from that particular projector 22 to be seen by more cameras 24.

In one embodiment, the number of light projectors 22 in probe 28 may range from two, e.g., as shown in row (iv) of FIG. 6, to six, e.g., as shown in row (xii). In one embodiment, the number of cameras 24 in probe 28 may range from four, e.g., as shown in rows (iv) and (v), to seven, e.g., as shown in row (ix). It is noted that the various configurations shown in FIG. 6 are by way of example and not limitation, and that the scope of the present disclosure includes additional configurations not shown. For example, the scope of the present disclosure includes more than five projectors 22 positioned in probe 28 and more than seven cameras positioned in probe 28.

In an example application, an apparatus for intraoral scanning (e.g., an intraoral scanner) includes an elongate wand comprising a probe at a distal end of the elongate wand, at least two light projectors disposed within the probe, and at least four cameras disposed within the probe. The light projectors may include one or more structured light projectors. Each light projector may include at least one light source configured to generate light when activated, and each structured light projector may further include a pattern generating optical element that is configured to generate a pattern of light when the light is transmitted through the pattern generating optical element. Each of the at least four cameras may include a camera sensor and one or more lenses, wherein each of the at least four cameras is configured to capture a plurality of images that depict at least a portion of the projected pattern of light on an intraoral surface. In one embodiment, a majority of the at least two light projectors and the at least four cameras may be arranged in at least two rows that are each approximately parallel to a longitudinal axis of the probe, the at least two rows comprising at least a first row and a second row.

In a further application, a distal-most camera along the longitudinal axis and a proximal-most camera along the longitudinal axis of the at least four cameras are positioned such that their optical axes are at an angle of 90 degrees or less with respect to each other from a line of sight that is perpendicular to the longitudinal axis. Cameras in the first row and cameras in the second row may be positioned such that optical axes of the cameras in the first row are at an angle of 90 degrees or less with respect to optical axes of the cameras in the second row from a line of sight that is coaxial with the longitudinal axis of the probe. A remainder of the at least four cameras other than the distal-most camera and the proximal-most camera have optical axes that are substantially parallel to the longitudinal axis of the probe. Each of the at least two rows may include an alternating sequence of light projectors and cameras.

In a further application, the at least four cameras comprise at least five cameras, the at least two light projectors comprise at least five light projectors, a proximal-most component in the first row is a light projector, and a proximal-most component in the second row is a camera.

In a further application, the distal-most camera along the longitudinal axis and the proximal-most camera along the longitudinal axis are positioned such that their optical axes are at an angle of 35 degrees or less with respect to each other from the line of sight that is perpendicular to the longitudinal axis. The cameras in the first row and the cameras in the second row may be positioned such that the optical axes of the cameras in the first row are at an angle of 35 degrees or less with respect to the optical axes of the cameras in the second row from the line of sight that is coaxial with the longitudinal axis of the probe.

In a further application, the at least four cameras may have a combined field of view of about 25-45 mm or about 20-50 mm along the longitudinal axis and a field of view of about 20-40 mm or about 15-80 mm along a z-axis corresponding to distance from the probe. Other FOVs discussed herein may also be provided.

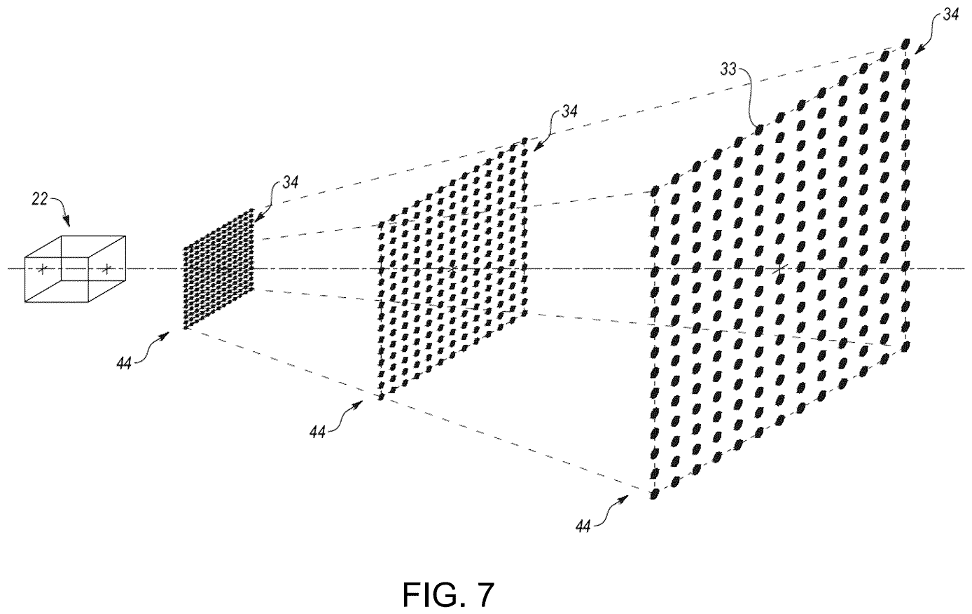

Reference is now made to FIG. 7, which is a schematic illustration of a structured light projector 22 projecting a distribution of discrete unconnected spots of light onto a plurality of object focal planes, in accordance with some applications of the present disclosure. FIGS. 7-19 are described with reference to a light pattern that comprises spots. However, the described solution to the correspondence problem works equally well for other light patterns (e.g., such as a checkerboard pattern). 3D surface 32A, 32B being scanned may be one or more teeth or other intraoral object/tissue inside a subject's mouth. The somewhat translucent and glossy properties of teeth may affect the contrast of the structured light pattern being projected. For example, (a) some of the light hitting the teeth may scatter to other regions within the intraoral scene, causing an amount of stray light, and (b) some of the light may penetrate the tooth and subsequently come out of the tooth at any other point. Thus, in order to improve image capture of an intraoral scene under structured light illumination, without using contrast enhancement means such as coating the teeth with an opaque powder, a sparse distribution 34 of discrete unconnected spots of light may provide an improved balance between reducing the amount of projected light while maintaining a useful amount of information. The sparseness of distribution 34 may be characterized by a ratio of: (a) illuminated area on an orthogonal plane 44 in field of illumination a (alpha), i.e., the sum of the area of all projected spots 33 on the orthogonal plane 44 in field of illumination a (alpha), to (b) non-illuminated area on orthogonal plane 44 in field of illumination a (alpha). In some applications, sparseness ratio may be at least 1:150 and/or less than 1:16 (e.g., at least 1:64 and/or less than 1:36).

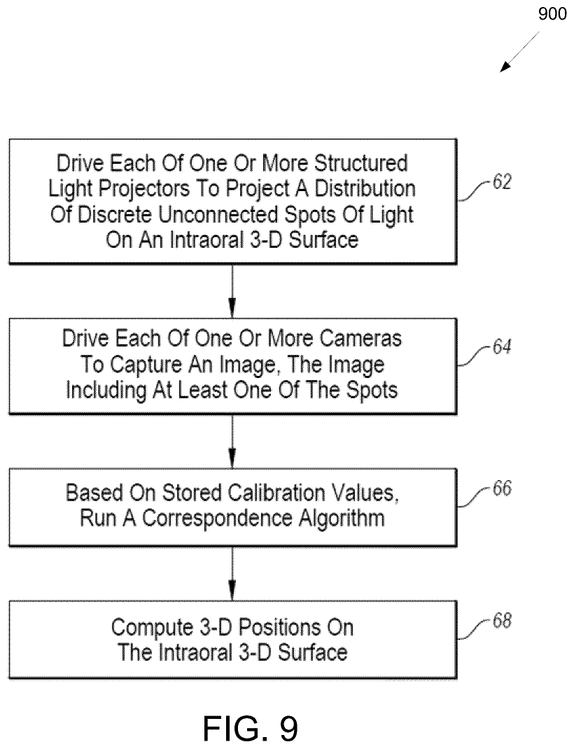

In some applications, each structured light projector 22 projects at least 400 discrete unconnected spots 33 onto an intraoral three-dimensional surface during a scan. In some applications, each structured light projector 22 projects less than 3000 discrete unconnected spots 33 onto an intraoral surface during a scan. In order to reconstruct the three-dimensional surface from projected sparse distribution 34, correspondence between respective projected spots 33 and the spots detected by cameras 24 is determined, as further described hereinbelow with reference to FIGS. 9-19.

Reference is now made to FIGS. 8A-B, which are schematic illustrations of a structured light projector 22 projecting discrete unconnected spots 33 and a camera sensor 58 detecting spots 33′, in accordance with some applications of the present disclosure. For some applications, a method is provided for determining correspondence between the projected spots 33 on the intraoral surface and detected spots 33′ on respective camera sensors 58. Once the correspondence is determined, a three-dimensional image of the surface is reconstructed. Each camera sensor 58 has an array of pixels, for each of which there exists a corresponding camera ray 86. Similarly, for each projected spot 33 from each projector 22 there exists a corresponding projector ray 88. Each projector ray 88 corresponds to a respective path 92 of pixels on at least one of camera sensors 58. Thus, if a camera sees a spot 33′ projected by a specific projector ray 88, that spot 33′ will necessarily be detected by a pixel on the specific path 92 of pixels that corresponds to that specific projector ray 88. With specific reference to FIG. 8B, the correspondence between respective projector rays 88 and respective camera sensor paths 92 is shown. Projector ray 88′ corresponds to camera sensor path 92′, projector ray 88″ corresponds to camera sensor path 92″, and projector ray 88″ corresponds to camera sensor path 92′″. For example, if a specific projector ray 88 were to project a spot into a dust-filled space, a line of dust in the air would be illuminated. The line of dust as detected by camera sensor 58 would follow the same path on camera sensor 58 as the camera sensor path 92 that corresponds to the specific projector ray 88.

During a calibration process, calibration values are stored based on camera rays 86 corresponding to pixels on camera sensor 58 of each one of cameras 24, and projector rays 88 corresponding to projected spots 33 of light from each structured light projector 22. For example, calibration values may be stored for (a) a plurality of camera rays 86 corresponding to a respective plurality of pixels on camera sensor 58 of each one of cameras 24, and (b) a plurality of projector rays 88 corresponding to a respective plurality of projected spots 33 of light from each structured light projector 22.

By way of example, the following calibration process may be used. A high accuracy dot target, e.g., black dots on a white background, is illuminated from below and an image is taken of the target with all the cameras. The dot target is then moved perpendicularly toward the cameras, i.e., along the z-axis, to a target plane. The dot-centers are calculated for all the dots in all respective z-axis positions to create a three-dimensional grid of dots in space. A distortion and camera pinhole model is then used to find the pixel coordinate for each three-dimensional position of a respective dot-center, and thus a camera ray is defined for each pixel as a ray originating from the pixel whose direction is towards a corresponding dot-center in the three-dimensional grid. The camera rays corresponding to pixels in between the grid points can be interpolated. The above-described camera calibration procedure is repeated for all respective wavelengths of respective laser diodes 36, such that included in the stored calibration values are camera rays 86 corresponding to each pixel on each camera sensor 58 for each of the wavelengths.

After cameras 24 have been calibrated and all camera ray 86 values stored, structured light projectors 22 may be calibrated as follows. A flat featureless target is used and structured light projectors 22 are turned on one at a time. Each spot is located on at least one camera sensor 58. Since cameras 24 are now calibrated, the three-dimensional spot location of each spot is computed by triangulation based on images of the spot in multiple different cameras. The above-described process is repeated with the featureless target located at multiple different z-axis positions. Each projected spot on the featureless target will define a projector ray in space originating from the projector.

Reference is now made to FIG. 9, which is a flow chart outlining a method 900 for determining depth values of points in an intraoral scan, in accordance with some applications of the present disclosure. Method 900 may be implemented, for example, at block 110 and 120 of method 101.

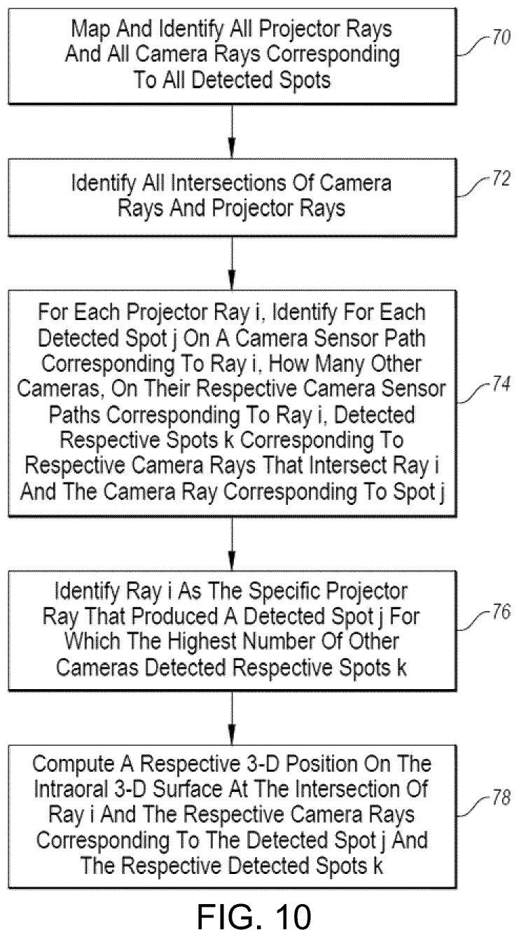

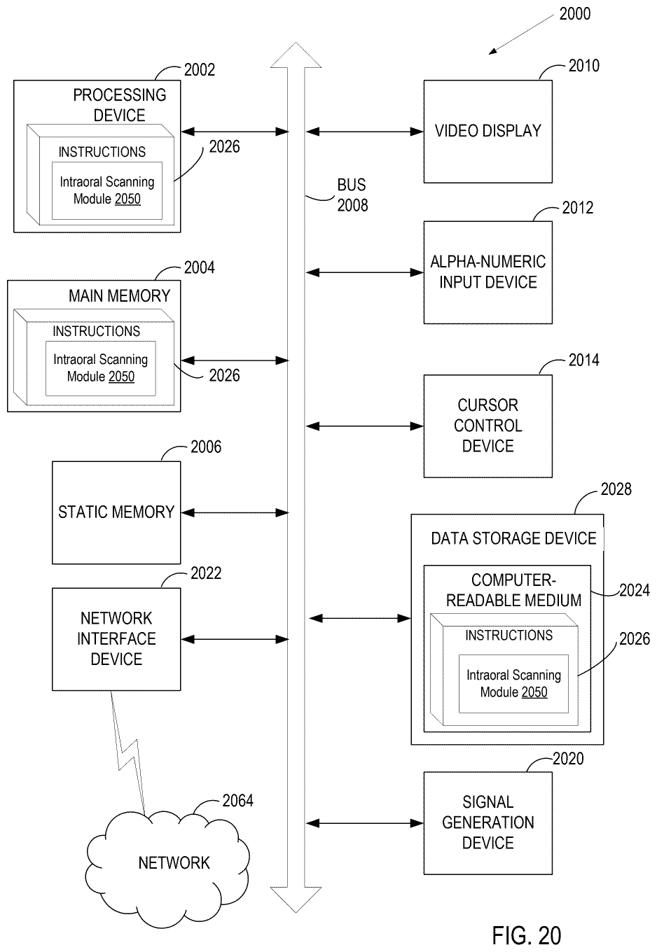

In operations 62 and 64, respectively, of method 900, each structured light projector 22 is driven to project distribution 34 of discrete unconnected spots 33 of light on an intraoral three-dimensional surface, and each camera 24 is driven to capture an image that includes at least one of spots 33. Based on the stored calibration values indicating (a) a camera ray 86 corresponding to each pixel on camera sensor 58 of each camera 24, and (b) a projector ray 88 corresponding to each projected spot 33 of light from each structured light projector 22, a correspondence algorithm is run in operation 66 using a processor 96, further described hereinbelow with reference to FIGS. 10-14. Processor 96 may be a processor of computing device 305 of FIG. 3 in embodiments, and may correspond to processing device 2020 of FIG. 20 in embodiments. Once the correspondence is solved, three-dimensional positions on the intraoral surface are computed in operation 68 and used to generate a digital three-dimensional image of the intraoral surface. Furthermore, capturing the intraoral scene using multiple cameras 24 provides a signal to noise improvement in the capture by a factor of the square root of the number of cameras.

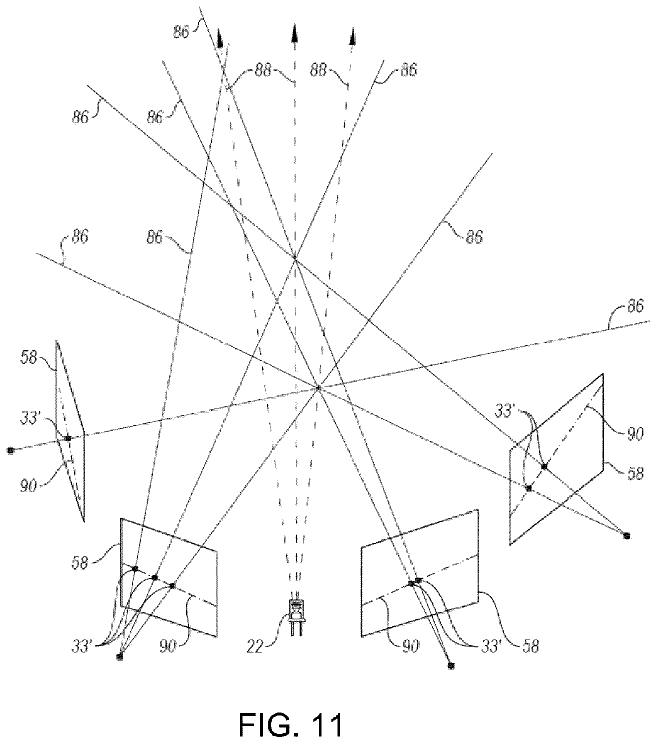

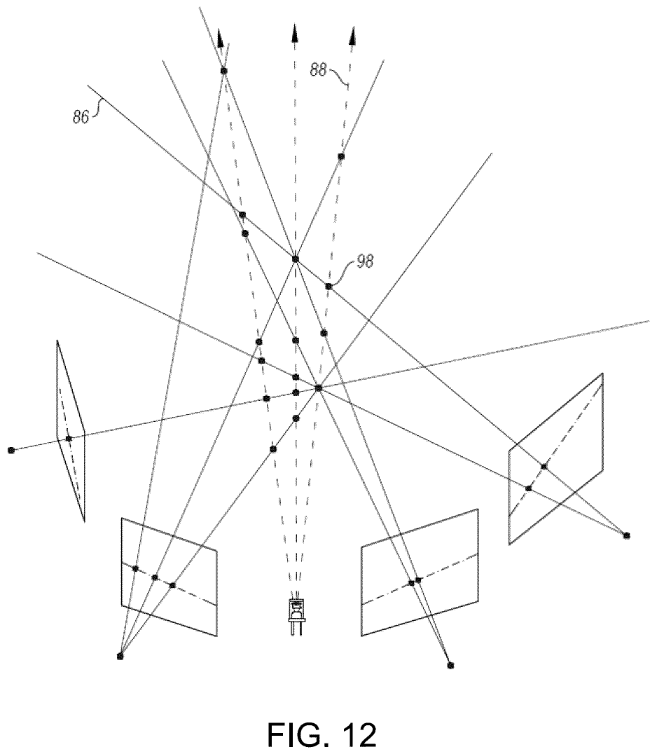

Reference is now made to FIG. 10, which is a flowchart outlining the correspondence algorithm of operation 66 in method 900, in accordance with some applications of the present disclosure. Based on the stored calibration values, all projector rays 88 and all camera rays 86 corresponding to all detected spots 33′ are mapped (operation 70), and all intersections 98 (FIG. 12) of at least one camera ray 86 and at least one projector ray 88 are identified (operation 72). FIGS. 11 and 12 are schematic illustrations of a simplified example of operations 70 and 72 of FIG. 10, respectively. As shown in FIG. 11, three projector rays 88 are mapped along with eight camera rays 86 corresponding to a total of eight detected spots 33′ on camera sensors 58 of cameras 24. As shown in FIG. 12, sixteen intersections 98 are identified.

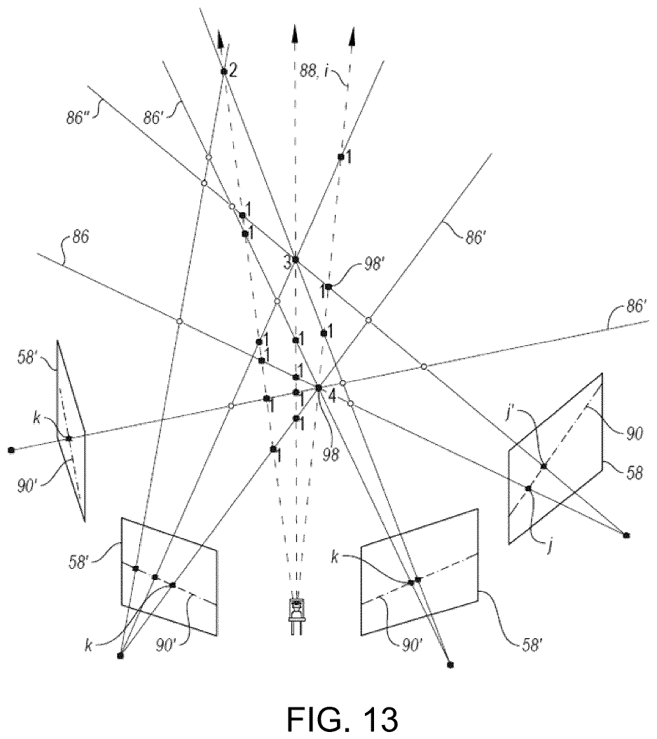

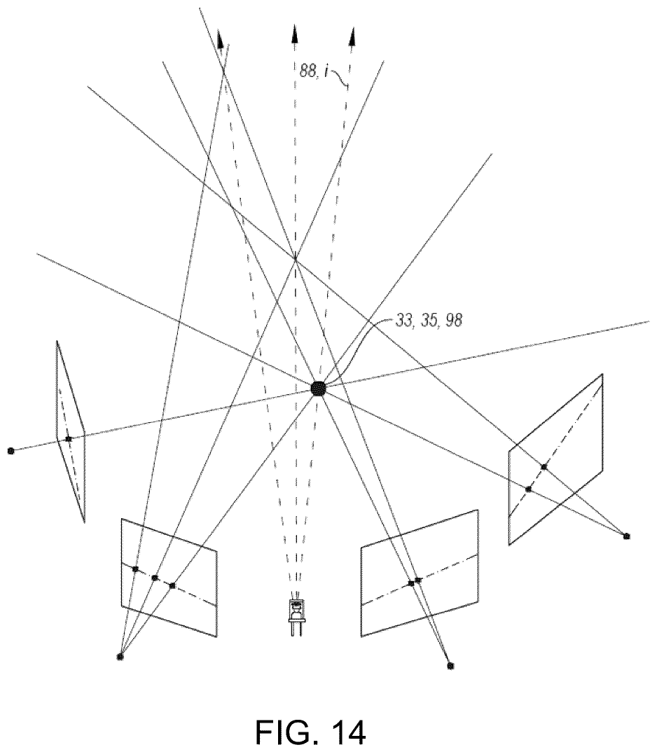

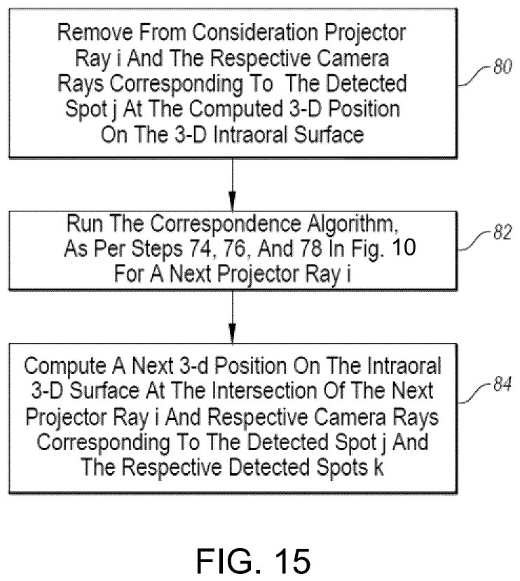

In operations 74 and 76 of method 900, processor 96 determines a correspondence between projected spots 33 and detected spots 33′ so as to identify a three-dimensional location for each projected spot 33 on the surface. FIG. 13 is a schematic illustration depicting operations 74 and 76 of FIG. 10 using the simplified example described hereinabove in the immediately preceding paragraph. For a given projector ray i, processor 96 “looks” at the corresponding camera sensor path 90 on camera sensor 58 of one of cameras 24. Each detected spot j along camera sensor path 90 will have a camera ray 86 that intersects given projector ray i, at an intersection 98. Intersection 98 defines a three-dimensional point in space. Processor 96 then “looks” at camera sensor paths 90′ that correspond to given projector ray i on respective camera sensors 58′ of other cameras 24, and identifies how many other cameras 24, on their respective camera sensor paths 90′ corresponding to given projector ray i, also detected respective spots k whose camera rays 86′ intersect with that same three-dimensional point in space defined by intersection 98. The process is repeated for all detected spots j along camera sensor path 90, and the spot j for which the highest number of cameras 24 “agree,” is identified as the spot 33 (FIG. 14) that is being projected onto the surface from given projector ray i. That is, projector ray i is identified as the specific projector ray 88 that produced a detected spot j for which the highest number of other cameras detected respective spots k. A three-dimensional position on the surface is thus computed for that spot 33.

For example, as shown in FIG. 13, all four of the cameras detect respective spots, on their respective camera sensor paths corresponding to projector ray i, whose respective camera rays intersect projector ray i at intersection 98, intersection 98 being defined as the intersection of camera ray 86 corresponding to detected spot j and projector ray i. Hence, all four cameras are said to “agree” on there being a spot 33 projected by projector ray i at intersection 98. When the process is repeated for a next spot j′, however, none of the other cameras detect respective spots, on their respective camera sensor paths corresponding to projector ray i, whose respective camera rays intersect projector ray i at intersection 98′, intersection 98′ being defined as the intersection of camera ray 86″ (corresponding to detected spot j′) and projector ray i. Thus, only one camera is said to “agree” on there being a spot 33 projected by projector ray i at intersection 98′, while four cameras “agree” on there being a spot 33 projected by projector ray i at intersection 98. Projector ray i is therefore identified as being the specific projector ray 88 that produced detected spot j, by projecting a spot 33 onto the surface at intersection 98 (FIG. 14). As per operation 78 of FIG. 10, and as shown in FIG. 14, a three-dimensional position 35 on the intraoral surface is computed at intersection 98.

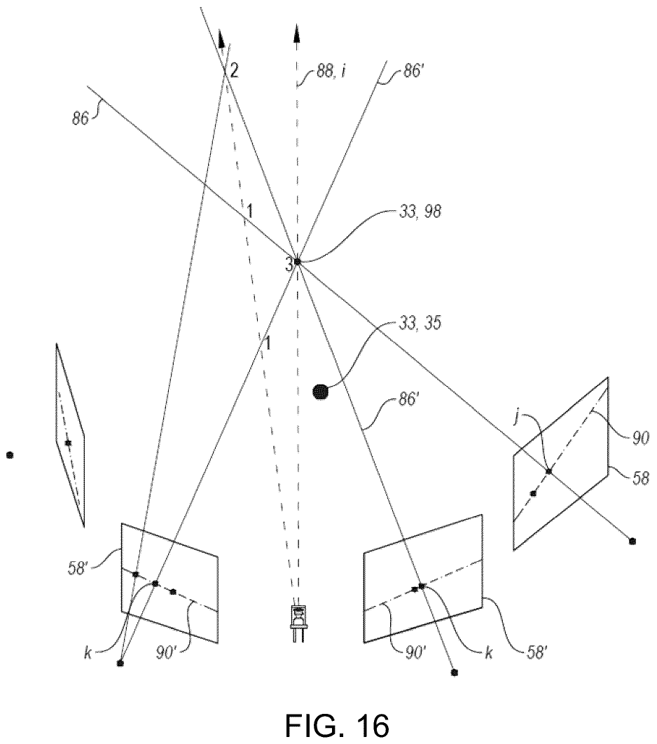

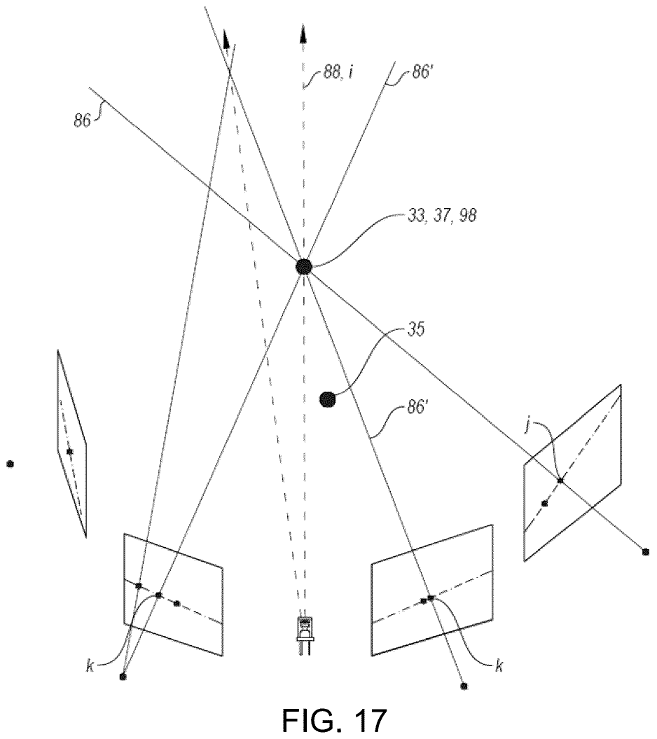

Reference is now made to FIG. 15, which is a flow chart outlining further operations in the correspondence algorithm, in accordance with some applications of the present disclosure. Once position 35 on the surface is determined, projector ray i that projected spot j, as well as all camera rays 86 and 86′ corresponding to spot j and respective spots k are removed from consideration (operation 80) and the correspondence algorithm is run again for a next projector ray i (operation 82). FIG. 16 depicts the simplified example described hereinabove after the removal of the specific projector ray i that projected spot 33 at position 35. As per operation 82 in the flow chart of FIG. 15, the correspondence algorithm is then run again for a next projector ray i. As shown in FIG. 16, the remaining data show that three of the cameras “agree” on there being a spot 33 at intersection 98, intersection 98 being defined by the intersection of camera ray 86 corresponding to detected spot j and projector ray i. Thus, as shown in FIG. 17, a three-dimensional position 37 is computed at intersection 98.

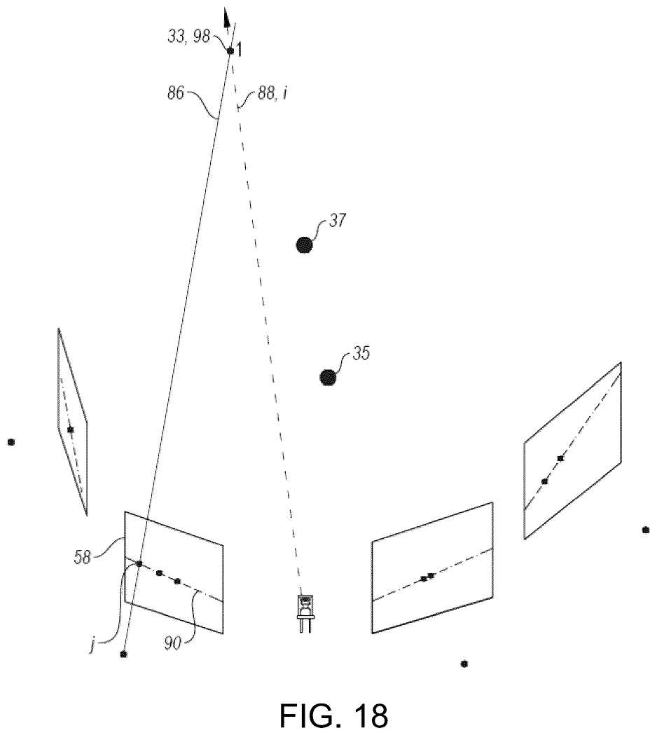

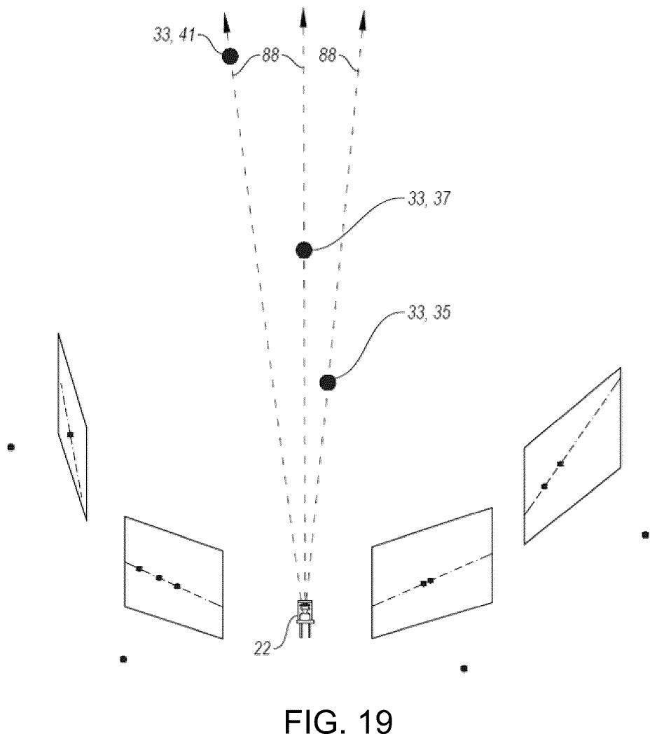

As shown in FIG. 18, once three-dimensional position 37 on the surface is determined, again projector ray i that projected spot j, as well as all camera rays 86 and 86′ corresponding to spot j and respective spots k are removed from consideration. The remaining data show a spot 33 projected by projector ray i at intersection 98, and a three-dimensional position 41 on the surface is computed at intersection 98. As shown in FIG. 19, according to the simplified example, the three projected spots 33 of the three projector rays 88 of structured light projector 22 have now been located on the surface at three-dimensional positions 35, 37, and 41. In some applications, each structured light projector 22 projects 400-3000 spots 33. Once correspondence is solved for all projector rays 88, a reconstruction algorithm may be used to reconstruct a digital image of the surface using the computed three-dimensional positions of the projected spots 33.

Reference is again made to FIG. 5A. For some applications, there is at least one uniform/smooth light projector 118 coupled to rigid structure 26. Uniform/smooth light projector 118 transmits white light onto 3D surface 32, 33 being scanned. At least one camera, e.g., one of cameras 24, captures two-dimensional color images of 3D surface 32A using illumination from uniform/smooth light projector 118. Processor 96 may run a surface reconstruction algorithm that combines at least one image captured using illumination from structured light projectors 22 with a plurality of images captured using illumination from uniform/smooth light projector 118 in order to generate a digital three-dimensional image of the intraoral three-dimensional surface. Using a combination of structured light and uniform/smooth illumination enhances the overall capture of the intraoral scanner and may help reduce the number of options that processor 96 needs to consider when running the correspondence algorithm.

FIG. 20 illustrates a diagrammatic representation of a machine in the example form of a computing device 2000 within which a set of instructions, for causing the machine to perform any one or more of the methodologies discussed herein, may be executed. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The example computing device 2000 includes a processing device 2002, a main memory 2004 (e.g., read-only memory (ROM), flash memory, dynamic random access memory (DRAM) such as synchronous DRAM (SDRAM), etc.), a static memory 2006 (e.g., flash memory, static random access memory (SRAM), etc.), and a secondary memory (e.g., a data storage device 2028), which communicate with each other via a bus 2008.

Processing device 2002 represents one or more general-purpose processors such as a microprocessor, central processing unit, or the like. More particularly, the processing device 2002 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 2002 may also be one or more special-purpose processing devices such as an application specific integrated circuit (ASIC), a field programmable gate array (FPGA), a digital signal processor (DSP), network processor, or the like. Processing device 2002 is configured to execute the processing logic (instructions 2026) for performing operations and operations discussed herein.

The computing device 2000 may further include a network interface device 2022 for communicating with a network 2064. The computing device 2000 also may include a video display unit 2010 (e.g., a liquid crystal display (LCD) or a cathode ray tube (CRT)), an alphanumeric input device 2012 (e.g., a keyboard), a cursor control device 2014 (e.g., a mouse), and a signal generation device 2020 (e.g., a speaker).

The data storage device 2028 may include a machine-readable storage medium (or more specifically a non-transitory computer-readable storage medium) 2024 on which is stored one or more sets of instructions 2026 embodying any one or more of the methodologies or functions described herein. Wherein a non-transitory storage medium refers to a storage medium other than a carrier wave. The instructions 2026 may also reside, completely or at least partially, within the main memory 2004 and/or within the processing device 2002 during execution thereof by the computer device 2000, the main memory 2004 and the processing device 2002 also constituting computer-readable storage media.

The computer-readable storage medium 2024 may also be used to store an intraoral scanning module 2050, which may correspond to similarly named components of FIG. 4. The computer readable storage medium 2024 may also store a software library containing methods that call an intraoral scanning module 2050, a scan registration module and/or a model generation module. While the computer-readable storage medium 2024 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, and optical and magnetic media.

It is to be understood that the above description is intended to be illustrative, and not restrictive. Many other embodiments will be apparent upon reading and understanding the above description. Although embodiments of the present disclosure have been described with reference to specific example embodiments, it will be recognized that the disclosure is not limited to the embodiments described, but can be practiced with modification and alteration within the spirit and scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

What is claimed is:

1. An intraoral scanning system, comprising:
an intraoral scanner configured to:
project first structured light onto an object at a first time;
capture first image data of the first structured light projected onto the object;
concurrently project second structured light and non-structured light onto the object at a second time; and
capture second image data of the second structured light and the non-structured light projected onto the object; and
one or more processing devices configured to:
generate a three-dimensional (3D) surface based on the first image data;
separate a structured light portion of the second image data from a non-structured light portion of the second image data;
determine a position and orientation of the non-structured light portion of the second image data relative to the 3D surface based on the structured light portion of the second image data; and
after determining the position and orientation of the non-structured light portion of the second image data relative to the 3D surface, augment the 3D surface using the non-structured light portion of the second image data.

2. The intraoral scanning system of claim 1, wherein the second structured light comprises a subset of the first structured light.

3. The intraoral scanning system of claim 1, wherein the first structured light and the second structured light each comprise a light pattern of coherent light comprising at least one of a first wavelength or a second wavelength.

4. The intraoral scanning system of claim 1, wherein the first structured light comprises first pattern features having a first wavelength and second pattern features having a second wavelength, and wherein the second structured light comprises at least some of the first pattern features having the first wavelength and lacks the second pattern features having the second wavelength.

5. The intraoral scanning system of claim 1, wherein the second structured light has a first wavelength and the non-structured light has one or more second wavelengths, and wherein separating the structured light portion from the non-structured light portion comprises:
determining a contribution of the second structured light to measured intensity values for one or more color channels; and
subtracting the determined contribution of the second structured light from the measured intensity values for the one or more color channels, wherein the non-structured light portion comprises a remainder from the subtracting.

6. The intraoral scanning system of claim 1, wherein the second structured light has a first wavelength and the non-structured light has one or more second wavelengths, and wherein separating the structured light portion from the non-structured light portion comprises performing the following for one or more pixels of the second image data:
determining intensity values for one or more color channels;
determining, for each color channel of the one or more color channels, a contribution of the second structured light to the intensity value and a contribution of the non-structured light to the intensity value.

7. The intraoral scanning system of claim 6, wherein the second structured light has a first color associated with a first color channel, and wherein the one or more processing devices are further to:
input the intensity values into a set of functions that account for a) crosstalk of the second structured light into one or more of a second color channel or a third color channel, and b) a relative response of the first color channel, the second color channel, and the third color channel to the non-structured light, wherein the set of functions output, for each color channel, a contribution to an intensity value of the color channel by the second structured light.

8. The intraoral scanning system of claim 1, wherein the one or more processing devices are further to:
after separating the structured light portion of the second image data from the non-structured light portion of the second image data, detect a plurality of pattern features from the structured light portion of the second image data; and
solve a correspondence algorithm for the plurality of pattern features to determine three-dimensional coordinates of the object represented in the second image data.

9. The intraoral scanning system of claim 1, wherein the one or more processing devices are further configured to:
identify one or more saturated pixels of in the second image data; and
filter out the one or more saturated pixels.

10. The intraoral scanning system of claim 1, wherein the second structured light has a first wavelength and the non-structured light comprises white light, and wherein the one or more processing devices are further configured to:
estimate a color of the object; and
separate the structured light portion from the non-structured light portion based at least in part on the estimated color of the object.

11. The intraoral scanning system of claim 1, wherein the first structured light is projected at a first intensity, wherein the second structured light is projected at a second intensity that is lower than the first intensity.

12. The intraoral scanning system of claim 1, wherein separating the structured light portion of the second image data from the non-structured light portion of the second image data comprises:
identifying pattern features of the structured light portion;
estimating a color of the object around the pattern features; and
using the estimated color of the object around the pattern features to determine how to separate the structured light portion of the second image data from the non-structured light portion of the second image data.

13. The intraoral scanning system of claim 1, wherein separating the structured light portion of the second image data from the non-structured light portion of the second image data comprises inputting the second image data into a trained artificial intelligence (AI) model, wherein the trained AI model outputs separation data.

14. The intraoral scanning system of claim 1, wherein the non-structured light comprises infrared or near-infrared light, wherein the object is a tooth, and wherein the one or more processing devices are further configured to:
determine a region of the tooth having an increased risk of caries; and
determine a light projection scheme in which the non-structured light is projected onto the region and the second structured light is not projected onto the region.

15. The intraoral scanning system of claim 1, wherein the one or more processing devices are further configured to:
detect at least one of a saturation level of the second image data or a number of detected pattern features of the second structured light captured in the second image data; and
adjust an intensity of the second structured light based on at least one of the saturation level or the number of pattern features.

16. A method comprising:
projecting first structured light onto an object at a first time;
capturing first image data of the first structured light projected onto the object;
generating a first point cloud based on the first image data;
concurrently projecting second structured light and non-structured light onto the object at a second time;
capturing second image data of the second structured light and the non-structured light projected onto the object;
separating a structured light portion of the second image data from a non-structured light portion of the second image data;
projecting the first structured light onto the object at a third time that is after the second time;
capturing third image data of the first structured light projected onto the object;
generating a second point cloud based on the third image data; and
stitching the first point cloud and the second point cloud using the separated structured light portion of the second image data.

17. The method of claim 16, wherein there is insufficient overlap between the first point cloud and the second point cloud to directly stitch the first point cloud to the second point cloud without use of the structured light portion of the second image data.

18. An intraoral scanning system, comprising:
an intraoral scanner configured to:
concurrently project structured light and non-structured light onto an object; and
capture image data of the structured light and the non-structured light projected onto the object; and
one or more processing devices configured to separate a structured light portion of the image data from a non-structured light portion of the image data.

19. The intraoral scanning system of claim 18, wherein the one or more processing devices are further configured to:
use at least one of the separated structured light portion of the image data or the non-structured light portion of the image data for at least one of registration, stitching, or augmentation with respect to a three-dimensional (3D) surface of the object.

20. The intraoral scanning system of claim 18, wherein the one or more processing devices are further configured to:
determine a position and orientation of the non-structured light portion of the image data relative to a three-dimensional (3D) surface of the object based on the structured light portion of the image data; and
after determining the position and orientation of the non-structured light portion of the image data relative to the 3D surface, augment the 3D surface using the non-structured light portion of the image data.
